(19) United States
(12) Patent Application Publication
(10) Pub. No.: US 2005/0144073 A1
(43) Pub. Date: Jun. 30, 2005

(54) Method and system for serving advertisements

(76) Inventors: Lawrence Morrisroe, Cupertino, CA (US); John Connelly, Santa Cruz, CA (US); Justin Everett-Church, Fremont, CA (US); Qi Lu, Saratoga, CA (US); Steven Milano, San Francisco, CA (US); David Shen, Cupertino, CA (US); Stanley Wong, Menlo Park, CA (US)

Correspondence Address: James J. DeCarlo, Esq.;Stroock & Stroock & Lavan LLP, 180 Maiden Lane, New York, NY, 10038, US

(21) Appl. No.: 10/928,532

(22) Filed: Aug. 26, 2004

Related U.S. Application Data
(63) Continuation-in-part of application No. 10/723,151, filed on Nov. 26, 2003.
(63) Continuation-in-part of application No. 10/456,742, filed on Jun. 5, 2003.
(60) Provisional application No. 60/515,322, filed on Oct. 28, 2003.
(60) Provisional application No. 60/386,268, filed on Jun. 5, 2002.
(60) Provisional application No. 60/520,210, filed on Nov. 14, 2003.

(51) Int. Cl. G06F 17/60

(52) U.S. Cl. 705/14

(57) ABSTRACT

An embodiment comprises a method and system for serving an advertisement. The method comprises identifying generic advertisement content to be provided to the user, identifying additional personalized advertisement content which is personalized to the user based on user information, and combining the personalized advertisement content with the generic advertisement content to create a personalized advertisement.

### CROSS-REFERENCE TO RELATED APPLICATIONS

This application is a Continuation-In-Part of U.S. patent application Ser. No. 10/723,151, entitled DISPLAY SYSTEM AND METHOD, filed Nov. 26, 2003, which claims the benefit of U.S. Provisional Patent Application Ser. No. 60/515,322, filed Oct. 28, 2003, entitled DISPLAY SYSTEM AND METHOD. This application is also a Continuation-In-Part of U.S. patent application Ser. No. 10/456,742, filed Jun. 5, 2003, entitled METHOD AND SYSTEM FOR PROVIDING A DYNAMICALLY CHANGING ADVERTISEMENT, which claims the benefit of U.S. Provisional Patent Application Ser. No. 60/386,268, filed on Jun. 5, 2002, entitled METHOD AND SYSTEM FOR PROVIDING A DYNAMICALLY CHANGING ADVERTISEMENT. This application also claims the benefit of U.S. Provisional Patent Application Ser. No. 60/520,210, filed Nov. 14, 2003, entitled METHOD AND SYSTEM FOR SERVING ADS. All of the above-mentioned applications are hereby incorporated by reference herein.

### BACKGROUND OF THE INVENTION

1. Description of Related Art

Advertising through use of the Internet and World Wide Web has become increasingly popular as a way to promote products and services to consumers. Use of the Internet to advertise products and services often takes the form of banner advertisements, pop-up advertisements, interstitials, frame advertisements, and the like. However, the effectiveness of these advertisements has been called into question. For example, users who routinely see the same advertisement may become bored, and ignore it. Indeed, due to the effort and expense in creating unique advertisements, many advertisements are reused, thus adding to their ineffectiveness. Furthermore, users will ignore advertisements that are irrelevant to the user, even if being viewed for the first time.

Consequently, efforts have been made to make advertisements more effective. In this regard, when accessing or “surfing” the Web, an Internet user now will typically encounter various advertisements targeted to him. To provide, or “serve,” such targeted advertisements, such as those described in U.S. Pat. No. 5,948,061, entitled “Method of Delivery, Targeting, and Measuring Advertising Over Networks,” U.S. Pat. No. 6,144,944, entitled “Computer System For Efficiently Selecting and Providing Information,” and U.S. Pat. No. 6,615,251 B1, entitled “Method for Providing Node Targeted Content in an Addressable Network,” systems typically select one of multiple advertisements based on the user's personal information.

Targeting advertisements by selecting one of multiple advertisements can be costly. For each category of user to which a targeted advertisement is to be served, a separate advertisement must be created and stored. With current trends to have greater levels of personalization, such a system can require an impractical number of different advertisements and amount of storage.

The large number of different advertisements is also detrimental when changing the advertising content. Where a change to the content affects multiple advertisements, each advertisement must be separately changed and uploaded. This changing of content and uploading of advertisements is an expensive, time-consuming endeavor.

Furthermore, because the revenue generated by a single advertisement is relatively small, the cost of creating and serving an advertisement must be kept relatively small. Cost considerations include, for example, both the time and expense of creating advertisements, as well as uploading, storing and updating advertisements. Accordingly, a need exists for an improved method and system for providing advertisements that generate user interest and response.

### SUMMARY OF THE INVENTION

The present invention satisfy these and other needs. In certain embodiments, a method and system is provided for serving an advertisement that dynamically changes with reference to certain data. One such method includes selecting personalized advertisement content based on the difference between first data and record data. The first data may be, for example, a launch date of a product and the second data may be, for example, the date on which the personalized advertisement is served to the user.

A method according to another embodiment comprises reading user information related to the user, the user information being electronically stored, identifying generic advertisement content to be provided to the user and identifying additional personalized advertisement content personalized to the user based on the user information. The personalized advertisement content is combined with the generic advertisement content to create the personalized advertisement.

Accordingly, in certain embodiments of the invention, a user may be served an advertisement including advertisement content based upon predetermined user criteria and/or information from user information storage alone or in addition to static or generic content. Thus, advertisements may be personalized and tailored to the user, providing additional content that may, in certain circumstances, be more pertinent to a user than would a generic advertisement not containing content chosen based on user information.

The generic advertisement content may comprise an advertisement file and combining the generic and personalized content may comprise incorporating the personalized content into the advertisement file.

In another embodiment, the personalized advertisement content comprises one or more search queries. The search queries are received from searchers and, based upon user information, are provided as part of a personalized advertisement.

In yet another embodiment, the method comprises making a first selection based on user information of an advertisement file and making a second selection, based on user information, of personalized advertisement content. The personalized advertisement is created by combining the selected personalized advertisement content with the selected advertisement file.

Systems are also provided for the foregoing methods, in which at least a part of one step is performed utilizing a computer.

### BRIEF DESCRIPTION OF THE DRAWING FIGURES

In the drawing figures, which are merely illustrative, and wherein like reference numerals depict like elements throughout the several views.

FIG. 1 is an exemplary system diagram of an embodiment of the invention;

FIG. 2 is an exemplary flow diagram illustrating an embodiment of the invention;

FIG. 3 is an exemplary schematic of a screen shot illustrating the content of an advertisement in accordance with an embodiment of the invention;

FIG. 4 is an exemplary screen shot illustrating an advertisement in accordance with an embodiment of the invention;

FIG. 5a is an exemplary work flow diagram illustrating an embodiment of the invention;

FIG. 5b is an exemplary work flow diagram illustrating another embodiment of the invention;

FIG. 6 is an exemplary work flow diagram illustrating another embodiment of the invention;

FIG. 7 is a workflow diagram illustrating the components and flow of data according to an embodiment of the invention;

FIG. 8 is a flowchart illustrating the process for monitoring search queries according to an embodiment of the invention;

FIG. 9 is a flowchart illustrating a process for reading information from the monitoring Web server and writing information to the select search server according to an embodiment of the invention;

FIG. 10 is a flowchart illustrating a process for demographic filtering according to an embodiment of the invention;

FIG. 11 is a flowchart illustrating a process for selecting and displaying search queries on the visual display device according to an embodiment of the invention;

FIGS. 12a-12c are exemplary advertisements on a Web page, incorporating scrolling filtered search queries according to certain embodiments of the invention; and

FIGS. 13-17 illustrate exemplary computer software that may be used to implement the advertisement of FIG. 12a according to an embodiment of the invention.

### DETAILED DESCRIPTION OF EXEMPLARY EMBODIMENTS

In general, the present invention relates to advertisements that may be provided or served via a network, such as the Internet, and whose content may be personalized based on user information. More specifically, the advertisement, which may be a file written in any of a number of computer languages, such as Macromedia Flash, Java, JavaScript and the like, is a type of template containing generic advertisement content that is combined with personalized advertisement content selected based user information, or data, related to the user. In certain embodiments, the user information includes the user's ZIP code, demographics, Web surfing history or any other information or data descriptive of the user. In certain embodiments, the content of the advertisement is based further on other factors, such as cookie data residing on the user's computer.

In certain embodiments, methods and systems are provided for serving an advertisement that dynamically changes with reference to data. One system according to the present invention provides dynamically changing advertisements and includes a Web server, an advertisement server and a user computer coupled to a network.

A method according to another embodiment involves retrieving data from a cookie stored on a user's computer, and dynamically changing an advertisement based upon the data from the cookie. The data may contain or reference user information.

As will be appreciated by those skilled in the art, the dynamic advertisement of certain embodiments provides several benefits over the prior art. For example, because the content dynamically changes, the provider of the advertisement need only upload the single advertisement rather than repeatedly uploading multiple static advertisements that collectively have the same content as the single dynamic advertisement. Consequently, the single dynamic advertisement saves not only technician time, but also electronic storage (memory) space. Moreover, it is anticipated that the dynamically changing advertisement will be more effective than static advertisements, as its message may be personalized based upon, among other things, information related to the user, such as the user's demographics, preferences, profile, surfing habits, and other user information.

As noted above, the content of the advertisement may be dynamically changed based on information related to the user. For example, the advertisement may include additional code to extract data from a cookie on the user's computer. This cookie data, or data referenced by the cookie, may be used as the only or one of multiple variables in determining which advertising content should be displayed to the user. In general, any information contained in a cookie could be used as a factor in determining the advertising content, including other sites visited by the user, the number of times the user has visited a particular Web site or Web page, demographics of the user and other user information. By way of example, a user logs into a Web site by providing a username and password. That username and password is associated with the user's profile, which includes various demographics, such as age, gender, address, hobbies, likes, dislikes, or any other information deemed relevant to the Web site provider or advertisers. Such demographic information, or a subset thereof, is stored in a cookie on the user's computer and can be accessed by the advertisement. In alternate embodiments, the cookie stores information identifying the user and the demographics for such user at a remote site such as a database server. Different advertisement content is associated with different demographics, thereby allowing the advertisement to dynamically change so that it is tailored to be effective to each user viewing it. In short, any information that can be reflected in or identified by a cookie can be extracted by the advertisement and used in the determination of what content to dynamically display to the user.

For example, in one such embodiment, the advertisement or Web page on which the advertisement runs may be programmed to place a cookie on the user's computer each time the user views the advertisement. The advertisement, in turn, would also include code that, based on the existence or absence of the cookie, determines whether or not the user is viewing the advertisement for the first time. Based upon the cookie information, as well as the current date, the advertisement with different, dynamically generated content is presented. In one such embodiment, various items of content could be used (e.g., equally) for a period of time, while the (same or separate) system evaluates the effectiveness of each item of content. Once the current date equals a specified date (for example, as determined by the advertisement server or web server) which thereby indicates the end of the evaluation period, the advertisement calls a predetermined Web site which specifies which item of advertisement content to use thereafter, either on a permanent basis or at particular times also as specified. The evaluation system advertisement criteria may be any of those known or hereafter known in the art, including for example, systems measuring click-throughs, customer acquisitions or other measures of effectiveness. In other of such embodiments, the evaluation period lasts until a predetermined number of users view the advertisement or content. Thus, the present invention allows for dynamic evaluation and modification of advertisements.

In yet another embodiment, the data that is used in connection with the changing of the advertisement may include information retrieved from one or more cookies regarding which Web sites the user has recently visited. For example, an advertisement may be changed to include content regarding a certain product if data on the user's computer shows that the user has visited a Web site that specialize in that certain product.

Alternatively, some or all of the demographic could be stored at a remote location in a user database. The advertisement content could similarly be based on this information, as stored remotely, rather than as stored in a cookie. In one such embodiment, information in a cookie on the user's computer provides a pointer or identifier for the stored demographics.

In another embodiment, the data that is used in connection with the changing of the advertisement may include data that is in the user's calendar, to do list or other application resident or the user's computer. For example, the advertisement may be altered to include content regarding birthday gifts if the data on a user's computer indicates that a birthday is approaching. Alternatively, the advertisement may include information related to a certain product if data that is retrieved from the end-user's computer indicates that the user might need that certain product.

In yet another embodiment, data related to the user's computer itself may be retrieved and an advertisement may be altered based upon that data. For example, if a user is running a certain type of computer, software or peripheral hardware, such as a printer or monitor, an advertisement's content might be altered to include content regarding a possible upgrade for that hardware or compatible products that are available.

In yet another embodiment, content within an advertisement can be changed to alert the user that an expiration date is approaching. For example, if a user is participating in an on-line auction or other time specific activity, content may be changed within an advertisement to alert the user that there is only a certain amount of time remaining until the end of the allotted time.

It is also to be understood that the advertisement content may be altered or based upon comparison of two or more items of data, such as date and cookie information. Furthermore, the content may be altered based upon comparison of one or more items of data, none of which are predetermined, for example, based solely on whether the user has viewed the advertisement previously. Furthermore, while exemplary embodiments have been described in which the difference between two items of data is used to alter or determine the content, the data could be applied to any type of algorithm or equation using such data (e.g., in which certain content is served based on time of day such as breakfast time, lunch time, and dinner time). As such, the term difference should be understood to encompass any algorithm or equation using the referenced data, including, but not limited to, mathematical difference between dates or other values. In certain embodiments, portions of the user information may be stored in a cookie residing on the user's computer, in a user database, and/or in a user sub-database.

As will be appreciated by those skilled in the art, advertisements containing personalized advertisement content based upon user information provide several benefits over the prior art. For example, the provider of the advertisement can provide advertisements having customized or personalized content, either alone or in addition to static or generic content, while only serving a single base advertisement rather than attempting to provide a separate advertisement to each of multiple individuals or groups, which may not be practical and would require the preparation of an unwieldy amount of individual advertisements. Consequently, the advertisements having additional personalized advertisement content based on user information save not only technician and programmer time, but also electronic storage (memory) space. Moreover, it is anticipated that an advertisement having additional personalized advertisement content based upon user information (either alone or in addition to static or other content) will be more effective than static advertisements, as its message may be personalized. In addition, in certain embodiments Internet advertisements may be used that provide advertising opportunities for non-Internet based purchases from brick-and-mortar local businesses, thus providing additional opportunities for Internet companies to raise revenues by selling advertisements at a localized (e.g., for a certain ZIP Code) level.

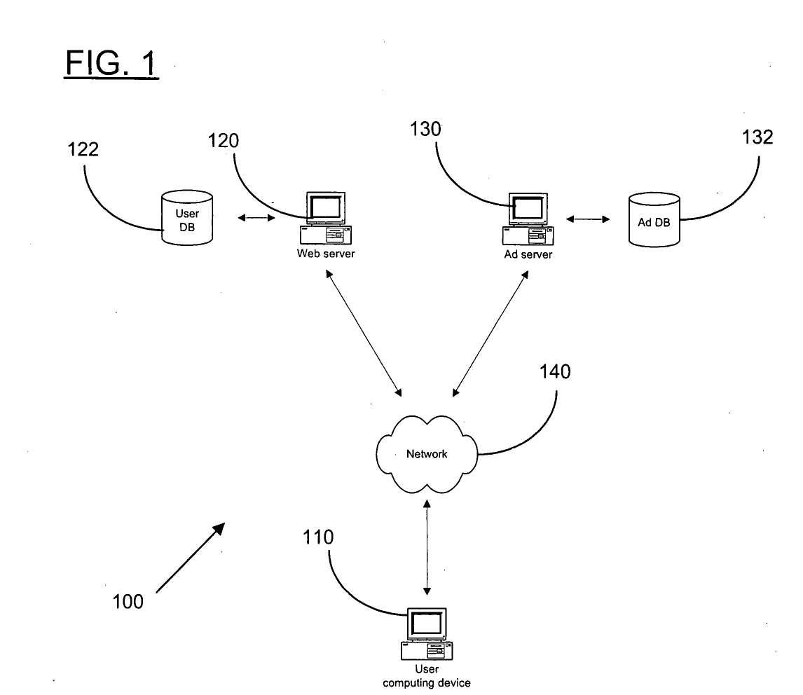

Certain embodiments will now be described in greater detail with reference to the figures. In general, with reference to FIG. 1, a system 100 in accordance with an embodiment for providing a personalized advertisement is shown. The user can access a Web page from a user computing device 110. The Web page may be provided by Web server 120. An advertisement may be served to user computing device 110 from advertisement server 130. Each of user computing device 110, Web server 120 and advertisement server 130 can be communicatively coupled via a network, such as the Internet. Portions of advertisement content may be stored at Advertisement database 132 and accessed by and served from advertisement server 130 to user computing device 110 based upon user information, which is stored at user database 122, as is described in further detail below.

User computing device 110 includes a scriptable browser, such as Internet Explorer, Netscape Navigator, Mozilla or Opera, or other program for interfacing with the network. The Web server 120 provides Web pages which are accessible by the user computing device 110. One of the Web pages includes reference to the advertisement of the present embodiment. Such an advertisement, which may contain portions written in HTML, XML, Macromedia Flash, Java, JavaScript, and the like is served by advertisement server 130, as is generally known in the art.

It is to be understood that the invention may be implemented utilizing any number of computer technologies. For example, although certain embodiments relate to providing access to content via the Internet, the invention may be utilized over any computer network, including, for example, a wide area network, local area network or, corporate intranet. Similarly, the user computing device 110 may be any computing device that may be coupled to the network, including, for example, personal digital assistants, Web-enabled cellular telephones, hard-wired telephones that dial into the network, mobile computers, personal computers, Internet appliances, wireless communication devices and the like. Furthermore, the servers described herein may be of any type, running any software, and the software modules, objects or plug-ins may be written in any suitable programming language.

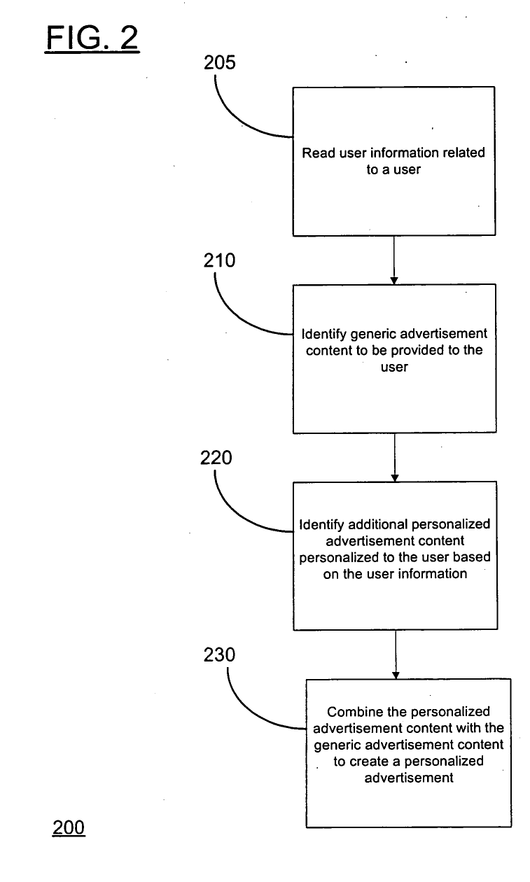

Having described the components of the system 100 its general operation will now be described with reference to FIG. 2. In general, first, the system reads user information related to the user, such as, for example, demographic information such as a user ZIP code. Step 205. Next the system identifies generic advertisement content to be provided to the user. Step 210. Next, the system identifies additional, personalized advertisement content personalized to the user based on the user information Step 220. This determination is made based on predetermined user criteria and information related to the user obtained from user information storage, such as a cookie on the user computing device 110, a remote database on the network, such as database 122, or the like. Indeed, even the identification of the generic context in step 210 may be based on user information with identification of the personalized content based on the same or additional user information.

Next, the personalized advertisement content is combined with the generic advertisement content to create the personalized advertisement. Step 230. The personalized and generic content can be combined prior to delivery to the user, or it can be combined at the user computing device. The personalized advertisement is then provided to the user computing device 110 for viewing by the user. The advertisement content includes personalized advertisement content that is included based upon user information related to the user obtained from user information storage. For example, a user's ZIP Code could be part of the user information related to the user and could be used such that the personalized advertisement content includes movie theatres near the user's ZIP Code.

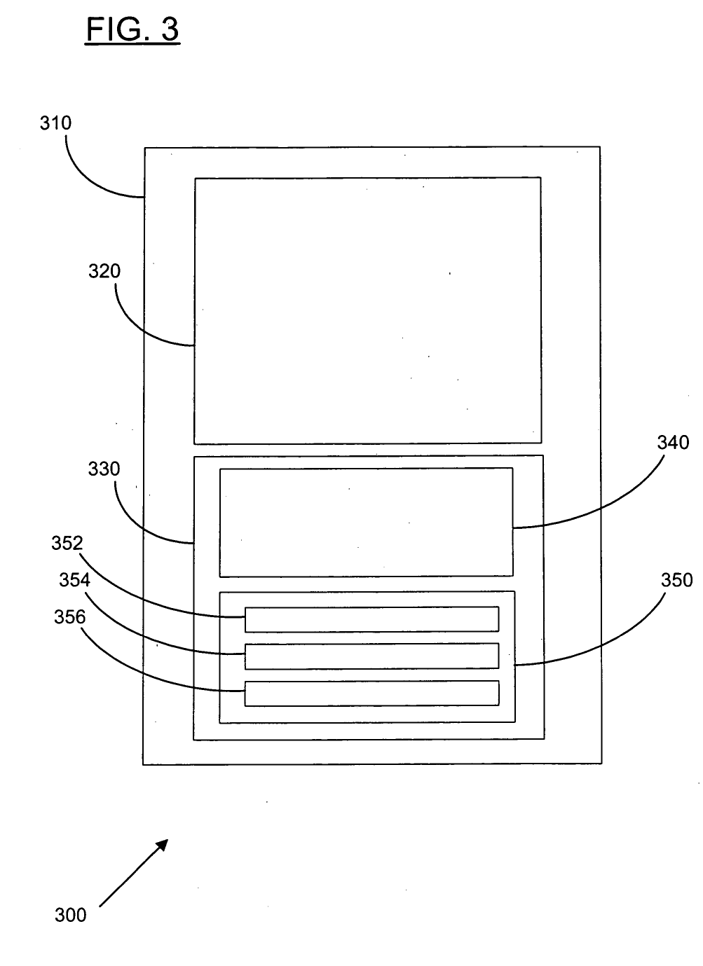

Turning to FIG. 3, there is shown an exemplary Web page 300 as would be viewed in certain embodiments of the invention. Web page 310 can include Web page content 320 and personalized advertisement 330. Personalized advertisement 330 may comprise generic advertisement content 340 and additional personalized advertisement content 350. Additional personalized advertisement content 350 can include additional personal advertisement content regions 352, 354, 356. When a user views Web page 310, personalized advertisement 330 includes generic advertisement content 340 and additional personalized advertisement content 350. Information related to the user is used to determine what additional advertisement content 350 should populate additional advertisement content regions 352, 354, 356 of additional personal advertisement content 350. For example, Web page 310 may contain Web content 320 which may be, for example, a movie review. Personalized advertisement 330 may include generic advertisement content 340 advertising a recently released movie, for example. Additional personalized advertisement content 350 might include, for example, the names of movie theatres showing the advertised movie and located near the user. The specific movie theater names populating additional personalized advertisement content fields 352, 354, 356 could be determined based on ZIP Code information obtained related to the user. In another example, personalized advertisement 330 can include personalized advertisement content 350 directed to a television program. In such an example, additional personalized advertisement content 350 might include, for example, television stations local to the user, as determined by ZIP code, and times when the advertised program could be viewed by the user. In still another example, personalized advertisement 330 might be advertising travel to, for example, a foreign city. In such an example, personalized advertisement content 350 might be directed to hotel names, telephone numbers, and addresses where a user might stay in that city. Links to the hotel Web site could also be provided. In yet another embodiment, personalized advertisement 330 might be directed to, for example, a chain of restaurants. In such an example, additional personalized advertisement content 350 might be directed to addresses of franchises of the restaurant chain local to the user. In addition, a coupon to the local restaurants could also be provided.

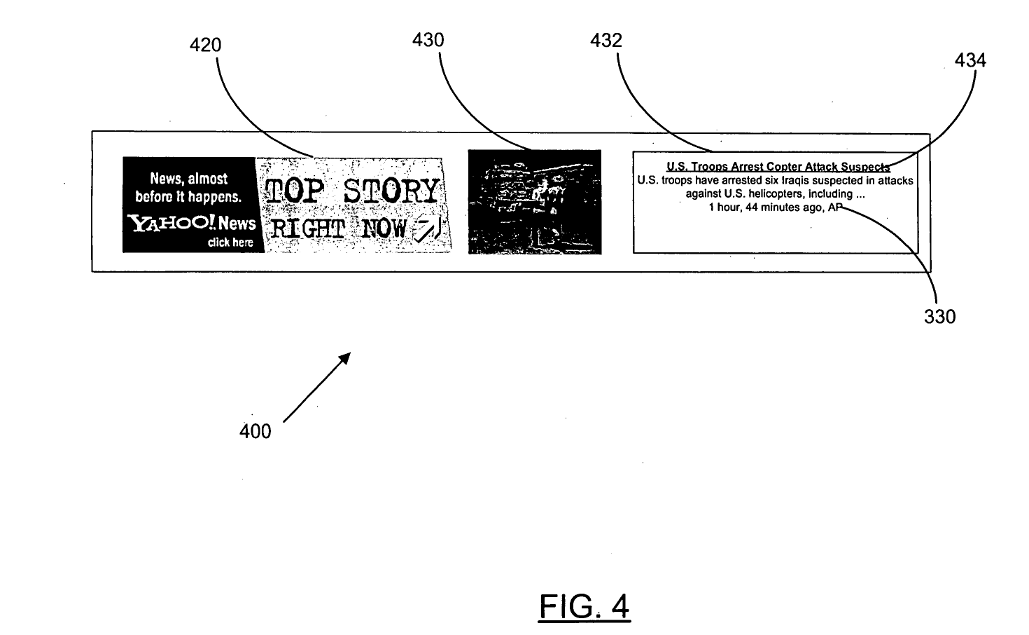

Turning now to FIG. 4, there is shown an exemplary screen shot of an advertisement served in accordance with an alternate embodiment of the invention. Advertisement 400 includes generic advertisement content 420 and additional personalized advertisement content 430. As discussed above, additional personalized advertisement content 430 is chosen based upon user information related to the user. Additional personalized advertisement content 430 may include, for example, text portions 434 and/or hyperlink content 432. If a user clicks on the hyperlink, the user's browser will be directed to a Web page as designated by the hyperlink.

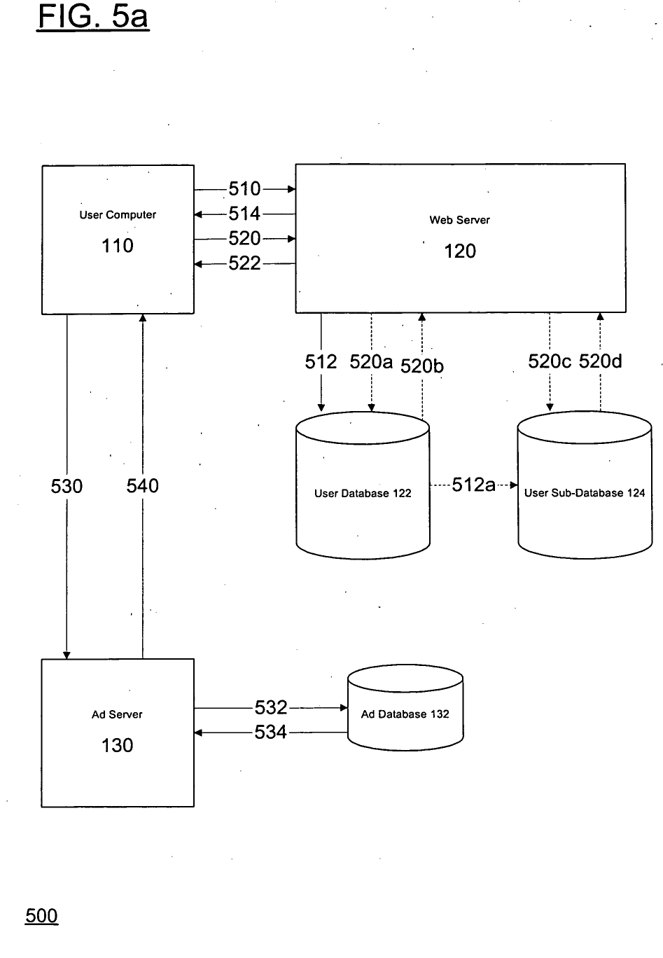

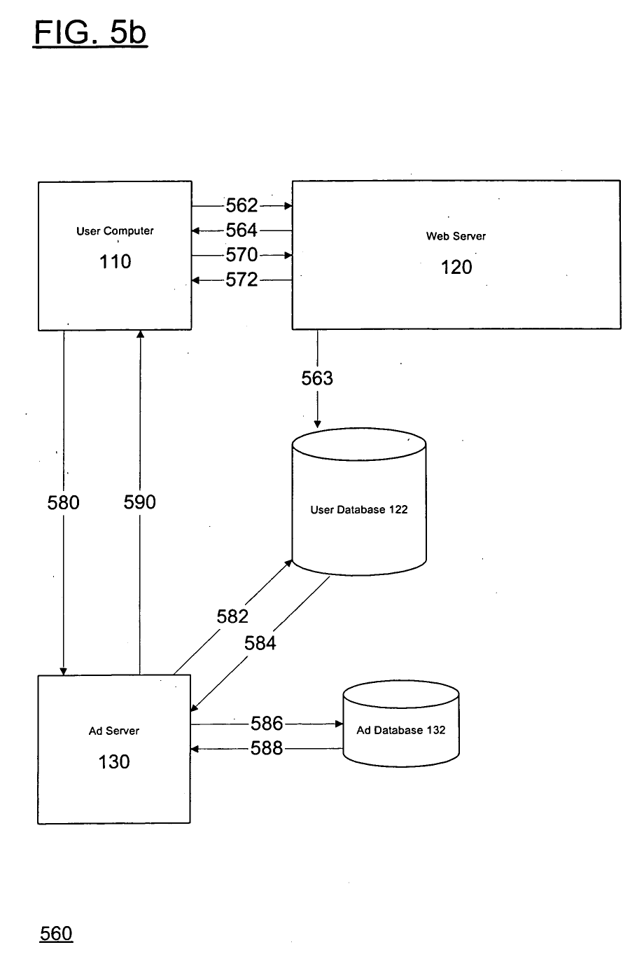

There is shown, in FIG. 5a, a work flow 500 in accordance with an embodiment of the invention in which user information is used to identify personalized advertisement content, and the personalized advertisement content is combined with generic advertisement content to create a personalized advertisement. The personalized advertisement, containing the combination of generic advertisement content and the personalized advertisement content can be provided to the user at the user's computing device.

First, a user employs a user computing device 110 to access a Web page from a Web server 120. Step 510. A Web page accessed from the user computing device 110 may include a registration Web page which can include one or more pages wherein the user may enter user information related to the user. Examples of information that may be entered are, for example, name, gender, age, address, favorite past times, sports, career, hobbies, favorite movie theaters and/or other information. The Web server 120 can save the pertinent user information to user database 122. Step 512. Next, Web server 120 can store a cookie on user computing device 110. Step 514. The cookie may contain some and/or all of the information entered into the user database 122. Alternatively, a cookie may include a reference ID number which identifies the user and is used by Web server 120 to associate the reference ID number with the user information at user database 122. In an alternative embodiment, the method may include step 512a wherein a user sub-database 124 is created which includes a subset of the user information in user database 122. Although not required, a benefit of creating user sub-database 124 is that a query of user sub-database 124 may be less computationally intensive than a query of user database 122, which includes relatively more user information. User sub-database 124 can be designed and implemented such that only user information most pertinent to the selection of the advertisement, generic advertisement content and additional personalized advertisement content can be included.

Next, a user may access a Web page having the advertisement from Web server 120. Step 520. User cookie ID information can then be obtained by Web server 120. Using the cookie ID information, Web server 120 requests user information from user database 122 (step 520a), and the user information is retrieved by Web server 120. Step 520b. Alternatively, the user information can be requested from user sub-database 124 (step 520c), and retrieved from the sub-database. Step 520d. Web server 120 then serves the requested Web page to user computing device 110. Step 522.

Embedded code in the requested Web page such as, for example, JavaScript, requests an advertisement from advertisement server 130, as is shown is step 530. The retrieved user information is also passed to advertisement server 130 along with the advertisement request. Advertisement server 130 then determines what advertisement to serve, using the retrieved user information. The user information can be used to determine both the generic advertisement content, as well as the personalized advertisement content. As described in greater detail below, that determination may be made by the performing of complex algorithms which take into consideration various variables such as, for example, what advertisements need to be served, the demographic and other user requirements needed for the various advertisements, and other such requirements. Once a determination of what advertisement to serve has been made, advertisement server 130 requests an advertisement from advertisement database 132, including generic advertisement content combined with personalized advertisement content. Step 532. The advertisement is pulled from advertisement database 132 by advertisement server 130. Step 534. The advertisement server 130 serves the advertisement to computing device 110. Step 540.

There is shown, in FIG. 5b, a work flow 566 in accordance with an embodiment of the invention in which user information is used to identify personalized advertisement content, and the personalized advertisement content is combined with generic advertisement content to create a personalized advertisement. The personalized advertisement, containing the combination of generic advertisement content and the personalized advertisement content can be provided to the user at the user's computing device.

First, a user employs a user computing device 110 to access a Web page from a Web server 120. Step 562. A Web page accessed from the user computing device 110 may include a registration Web page which can include one or more pages wherein the user may enter user information related to the user. Examples of information that may be entered are, for example, name, gender, age, address, favorite past times, sports, career, hobbies, favorite movie theaters and/or other information. The Web server 120 can save the pertinent user information to user database 122. Step 563. Next, Web server 120 can store a cookie on user computing device 110. Step 564. The cookie may contain some and/or all of the information entered into the user database 122. Alternatively, a cookie may include a reference ID number which identifies the user and is used by Web server 120 to associate the reference ID number with the user information at user database 122.

Next, a user may access a Web page having the advertisement from Web server 120. Step 570. User cookie ID information can then be obtained by Web server 120. Web server 120 then serves the requested Web page to user computing device 110. Step 522.

Embedded code in the requested Web page such as, for example, JavaScript, requests an advertisement from advertisement server 130, as is shown is step 580. The retrieved user information is also passed to advertisement server 130, along with the advertisement request. Advertisement server 130 then uses the user cookie ID information to request user information from user database 122. Step 582. The pertinent user information is then retrieved by advertisement server 130. Step 584. Advertisement server 130 then determines what advertisement to serve, using the user cookie ID information. The user information can be used to determine both the generic advertisement content (e.g., which advertisement file or template out of multiple files to use), as well as the personalized advertisement content (e.g., personalized content within the selected advertisement file). As described in greater detail below, that determination may be made by the performing of complex algorithms which take into consideration various variables such as, for example, what advertisements need to be served, the demographic and other user requirements needed for the various advertisements, and other such requirements. Once a determination of what advertisement to serve has been made, advertisement server 130 requests an advertisement from advertisement database 132, including generic advertisement content combined with personalized advertisement content. Step 586. The advertisement is pulled from advertisement database 132 by advertisement server 130. Step 588. The advertisement server 130 serves the advertisement to computing device 110. Step 590.

As described above, the personalized advertisement content of the advertisement may be based on various types of information related to the user. For example, the advertisement may include additional code to extract data from a cookie on the computing device 110. This information may be used as a variable in determining which version of the advertisement should be displayed to the user. In general, any information contained in a cookie could be used as a factor in determining the additional advertisement content, including other sites visited by the user, the number of times the user has visited a particular Web site or Web page, demographics of the user, ZIP Code of the user, and the like. By way of example, a user logs into a Web site by providing a username and password. That username and password is associated with the user's profile which includes various demographics such as age, gender, address, hobbies, likes, dislikes, or any other information deemed relevant to the Web site provider or advertisers. Such demographic information, or a subset thereof, is stored in a cookie on the user's computer and can be accessed by the advertisement. In alternate embodiments, the cookie stores information identifying the user and the demographics for such user at a remote site such as a database server. Different advertisement content is associated with different demographics, thereby allowing the advertisement to be personalized so that it is tailored to be effective to each user viewing it. In short, any information that can be reflected in a cookie can be extracted from the advertisement and used in the determination of what content to dynamically display to the user.

In certain embodiments, subsequent to information related to the user (e.g., profile) being stored, the user may direct a browser to load a Web page from the Web server, wherein the Web page includes an advertisement. By way of JavaScript or other code in the Web page, the browser is caused to call to the advertisement server (or, for example, a movie server having information pertaining to movies to be advertised). The browser, when making the call to the advertisement server, appends certain parameters from, for example, the Web page and/or advertisement, to the URL and passes the parameters to the advertisement server. Parameters that can be passed include any parameters to define dynamic (e.g., personalized) content. By way of no n-limiting example, in the case of an advertisement for advertising a movie and displaying theaters local to the user and show times for the movie, the parameters may include the movie title, the number of theaters for which information is retrieved from the advertisement server and associated advertisement database and displayed, the number of show times per theater to retrieve and display, and/or a ZIP Code, identifying the locality of the user and theaters. Next, code at the advertisement server, such as, for example, JavaScript, causes information from an advertisement database to be pulled based on the passed parameters.

In certain embodiments, the advertisement server also checks for the presence of a cookie at the user computer. The cookie can contain user personal information, such as, for example, information in the user's profile, for example, the user's ZIP Code. The personal information is passed to the advertisement server as a type of parameter. Alternatively, the cookie may contain an ID number or other identifier to facilitate referencing of user information from the database, such as profile information, preference information, theater preference information, ZIP Code information, and/or other information related to the information to be pulled from the database. If the cookie is present, all or a portion of it is provided to the advertisement server as a type of parameter. The advertisement server, in turn, pulls the user personal information and, based on such information, identifies personal content to be included as part of the advertisement. In the example of a movie advertisement, the cookie may identify the user's ZIP code, as well as preferred theaters. The advertisement server accesses the database and retrieves information pertaining to the preferred movie theaters and/or theaters within a predetermined range from the user's ZIP code. If no cookie is present at the user computer, in certain embodiments, the user can be prompted to enter ZIP Code and/or other personal information, which is passed to the advertisement server and used as any information retrieved from the cookie or database for adding personalized content.

Although in certain embodiments the additional personalized advertisement content can be text, it is within the scope of the invention to provide for advertisements where the additional personalized advertisement content based upon user information includes, for example, artwork, graphics, animation, audio, video and the like. In addition, in certain embodiments, both the selection of generic advertisement content (e.g., selecting an advertisement file from multiple advertisement files) and the selection of personalized advertisement content (e.g., from multiple items of personalized advertisement content) can be based on the user information. In such embodiments, the method can include reading user information related to the user, based on the user information, selecting generic advertisement content (e.g., an advertisement file) from multiple items of generic advertisement content, based on the user information, selecting personalized advertisement content from multiple items of personalized advertisement content, the selected personalized advertisement content being personalized to the user, and creating the personalized advertisement by combining the selected personalized advertisement content with the selected generic advertisement content.

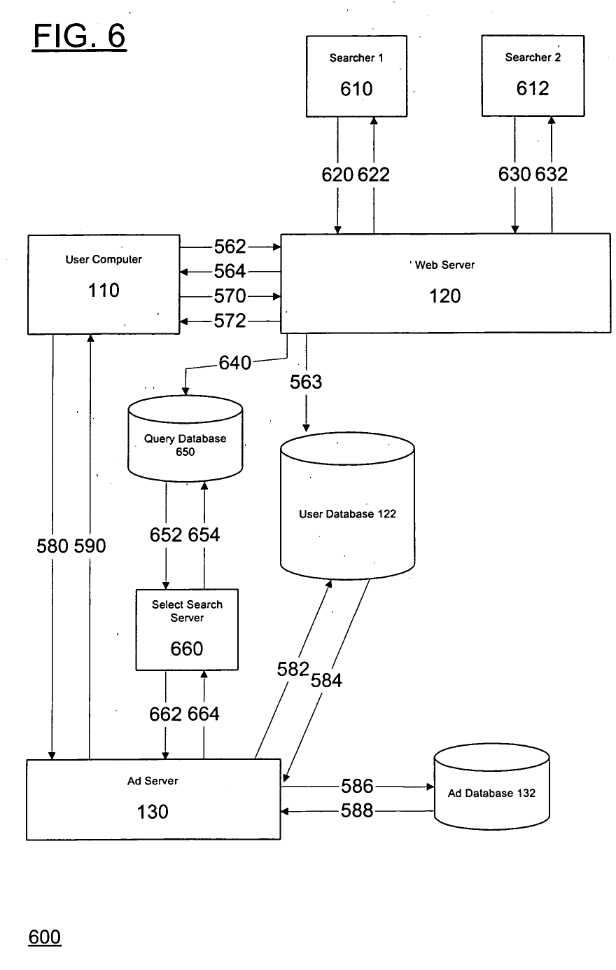

In certain embodiments, the content personalized to a particular user is based on inputs of other users. In one such embodiment, the personalized content comprises search queries entered by other users, or “searchers”. One such embodiment will now be described with reference to FIGS. 6-16.

FIG. 6 illustrates an exemplary work flow 600 in which any number of users entering search queries, referred to as searcher 1 (610) and searcher 2 (612), perform Internet keyword searches using a search engine. Searcher 1 (610) generates query 1 (620). Similarly, searcher 2 generates query 2 (630). Each searcher 610, 612 has associated demographic information, for example as provided during searchers' registration with a Web site. Query 1 (630) and query 2 (630), including related demographic information related to searcher 1 (610) and searcher 2 (612), are stored at query database 650. Query database 650 can also be coupled to user database 122, which may contain demographic information related to the searchers 610, 612. The demographic information may preexist in the query database 650, or may be extracted from a cookie on the searchers' computers, or may be extracted from another source.

First, a user employs a user computing device 110 to access a Web page from a Web server 120. Step 562. A Web page accessed from the user computing device 110 may include a registration Web page which can include one or more pages wherein the user may enter user information related to the user. Examples of information that may be entered are, for example, name, gender, age, address, favorite past times, sports, career, hobbies, favorite movie theaters and/or other information. The Web server 120 can save the pertinent user information to user database 122. Step 563. Next, Web server 120 can store a cookie on user computing device 110. Step 564. The cookie may contain some and/or all of the information entered into the user database 122. Alternatively, a cookie may include a reference ID number which identifies the user and is used by Web server 120 to associate the reference ID number with the user information at user database 122.

Next, a user may access a Web page having the advertisement from Web server 120. Step 570. User cookie ID information can then be obtained by Web server 120. Web server 120 then serves the requested Web page to user computing device 110. Step 522.

Embedded code in the requested Web page such as, for example, JavaScript, requests an advertisement from advertisement server 130, as is shown is step 580. The retrieved user information is also passed to advertisement server 130 along with the advertisement request. Advertisement server 130 then uses the user cookie ID information to request user information from user database 122. Step 582. The pertinent user information is then retrieved by advertisement server 130. Step 584. Advertisement server 130 then determines what advertisement to serve, using the user cookie ID information. The user information can be used to determine both the generic advertisement content, as well as the personalized advertisement content. Once a determination of what advertisement to serve has been made, advertisement server 130 requests an advertisement from advertisement database 132, including generic advertisement content. Step 586. The advertisement is pulled from advertisement database 132 by advertisement server 130. Step 588. Personalized advertisement content, including queries selected based on the user information, is retrieved from select search server 660. Step 662. The advertisement server 130 serves the advertisement to computing device 110. Step 590. The advertisement includes generic advertisement content, combined with personalized advertisement content, including queries from the searchers.

More specifically, although other algorithms can be used to determine what personalized content is included in the advertisement, the present embodiment selects queries from searchers having demographic similar to the user receiving the advertisement. For example, the user and searcher could live near each other, have visited the same or similar Web Sites, and the like. A similar sequence can be performed with regard to a Web page request from the other user m 112, using demographic information stored in a cookie on the computer of user m (112) or otherwise.

In alternate embodiments, the demographic information related to the users and searchers need not be stored in a cookie on the users' computers, but could be stored at user database 122, and associated with the users by way of a login ID provided at a user interface, or stored in a cookie on the users' computer.

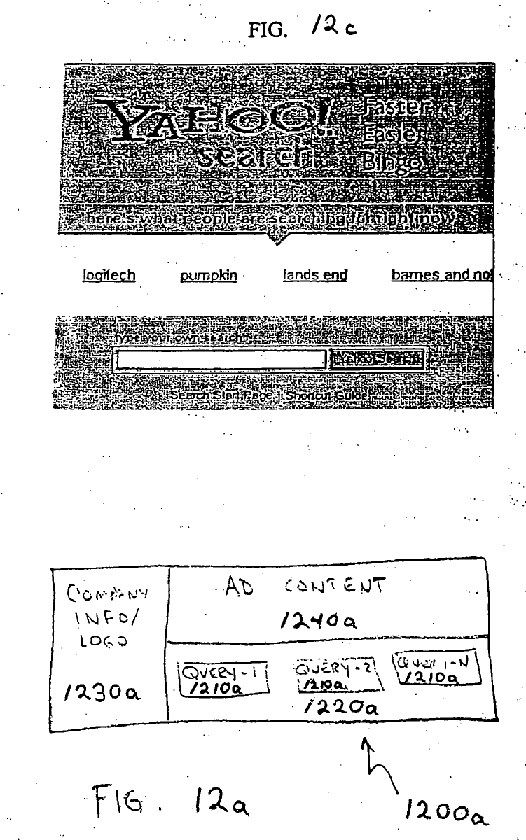

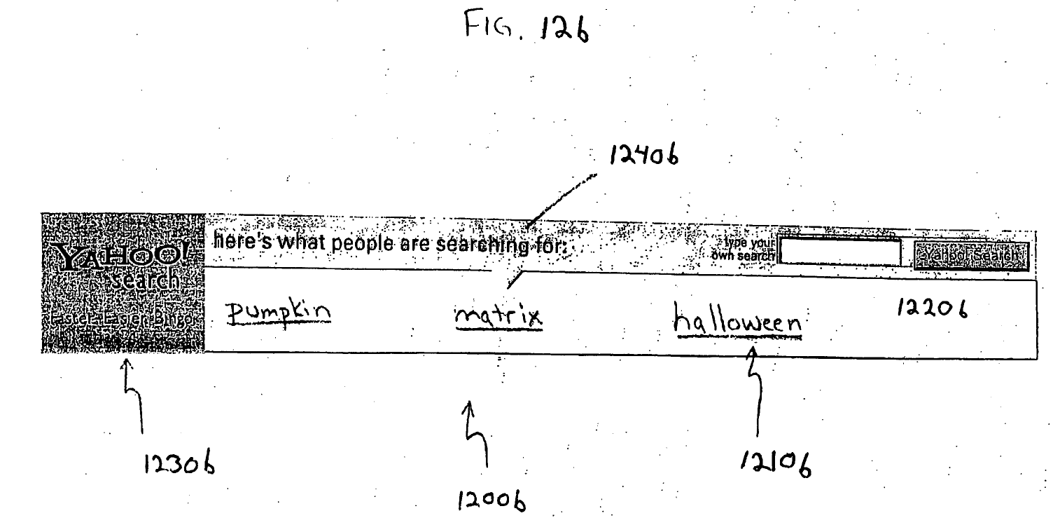

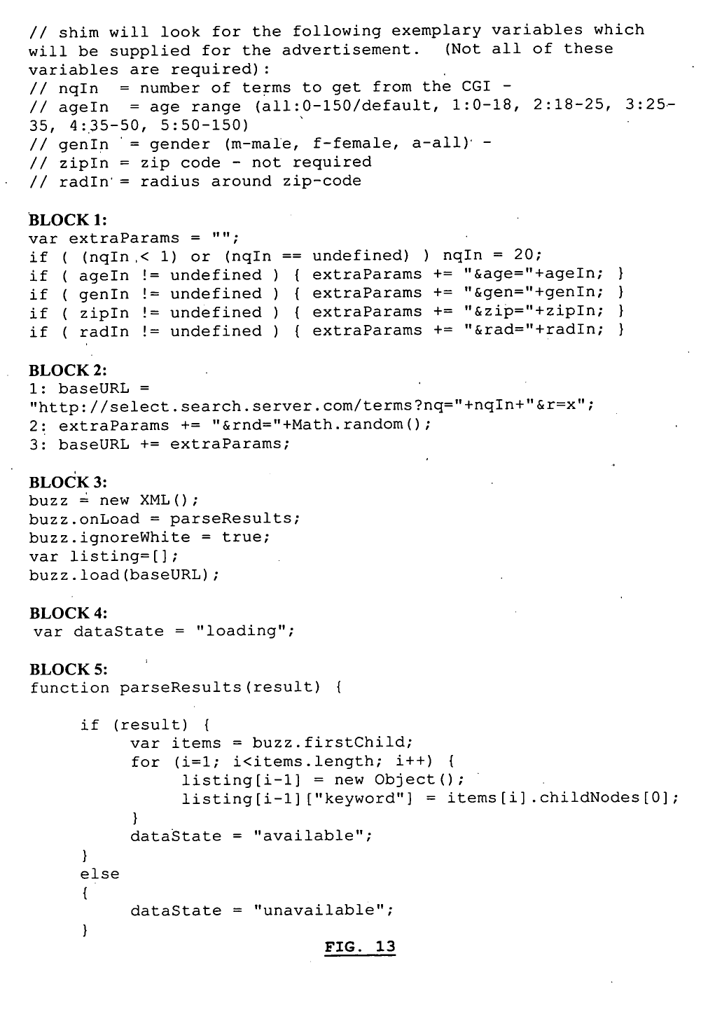

FIG. 12a illustrates an exemplary advertisement served by the workflow of FIG. 6. As shown, the advertisement 1200a has a region 1220a with scrolling search queries 1210a from searches with similar demographic information to the user. In this manner, search queries 1210a that might be relevant to the user may be displayed. In addition, personalized advertisement content 1240a could also be displayed, the advertisement content being selected based upon the demographic information related to the user.

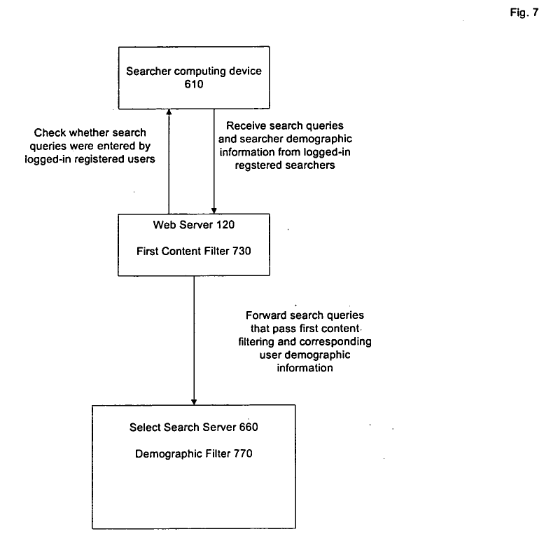

FIG. 7 illustrates an exemplary workflow 700 illustrating certain components and flow of data according to one embodiment. This embodiment includes: a searcher computing device 610, a Web server 120, a first content filter 730, a select search server 660, and a demographic filter 770.

In the presently described embodiment, the Web server 120 is a computing device or processor, communicatively coupled to one or more searcher computing devices 610 and the select search server 660, via any of a number of networks, such as a local area network, wide area network, the Internet, wireless network, satellite transmission, virtual private network and the like, utilizing essentially any type of communication protocol, such as Ethernet, IP addressing, transmission via data packets and the like. The Web server 120 functions automatically to perform certain tasks, such as monitoring and retrieving search queries entered by users to a search engine at one or more searcher computing devices 610, retrieve available user demographic information for the user that entered a search query, and/or forward search queries and the corresponding user demographic information to one or more filters that remove certain search queries in accordance with desired predetermined filtering criteria. It is to be understood by those skilled in the art that a search term includes, but is not limited to, words and phrases. Additionally a search query includes, but is not limited to one or more words and/or phrases and/or characters or symbols used to facilitate a search, such as “and”, “+”,“!”, “*”. The following are exemplary filters in the presently described embodiment.

The first content filter 730 is preferably a software object or program running on the Web server 120 that functions automatically to remove search queries containing search terms found in a “bad words” hash table. The first content filter 730 forwards to the select search server 660 each remaining search query and the corresponding user demographic information.

The select search server 660 is a computing device or processor communicatively coupled to one or more monitoring Web servers 720 by any one of the above-mentioned networks, type of protocols, and the like. The select search server 660 receives each remaining search query and corresponding user demographic information, after the filtering process has been completed.

The demographic filter 770 is preferably a software object or program running on the select search server 660 that reads the remaining search queries and corresponding user demographic information in memory and removes search queries having corresponding user demographic information that does not match the demographic fields found in a “desired demographics” hash table. The demographic filter 770 stores the remaining search queries and corresponding user demographic information in memory.

Having generally described the components of the present embodiment, each component will now be described in greater detail. As illustrated, the searcher computing device 610 is a computing device or processor, such as a personal computer (PC), personal digital assistant (PDA), Web-enabled cellular telephone, and the like. Furthermore, each searcher computing device 610 preferably includes a graphical user interface that is capable of displaying an Internet browser, such as that offered by Microsoft Corporation under the tradename INTERNET EXPLORER. A search engine offered by a system provider, such as that offered by Yahoo! Inc. under the tradename YAHOO! SEARCH provides an Internet-accessible search service that enables a user to enter search queries, via a graphical user interface presented on the searcher computing device 610 via a Web browser, to search for information on the Internet.

As an initial matter, searchers may register with the system provider of the search engine, such as that offered by Yahoo! Inc. under the tradename YAHOO!. In general, such registration includes prompting the searcher to provide the system provider with information by requiring the searcher to enter a plurality of information fields, including user demographic information fields (such as home address, work address, telephone number, email address, gender, ethnicity, birth date, job description, ZIP code, or any other user input data).

In one embodiment, the searcher provides the above-mentioned information via a secure Web page generated by the system provider of the search engine. The system provider receives the information via the Internet and electronically writes and stores the information via a local area network to an account database. In an alternate embodiment, the searcher manually provides the information to the system provider, where an employee of the system provider, in turn, manually enters the information into an account database. In either embodiment, once the system provider receives the account information fields and the searcher demographic information fields, a searcher ID is assigned to the user and the corresponding record in the database is populated.

The Web server 120 is a computing device or processor, communicatively coupled to one or more searcher computing devices 610 and the select search server 660, via any of a number of networks, such as a local area network, wide area network, the Internet, wireless network, virtual private network and the like, utilizing essentially any type of communication protocol, such as Ethernet, IP addressing, transmission via data packets and the like. The Web server 120 functions automatically to monitor search queries entered by logged-in registered users to a search engine at one or more searcher computing devices 610. When a registered user enters his or her user ID and password to the system provider of the search engine at the searcher computing device 610, the Web server 120 generates a cookie that is sent to the searcher computing device 610. All subsequent information transmitted from the searcher computing device 610 to the Web server 120 will include this cookie information, which includes the user ID and user's demographic information.

When a registered searcher enters a search query at the searcher computing device 610, the search query, along with the user's cookie information (including the searcher's searcher demographic information and IP address of the searcher computing device 610), is sent to the Web server 120. The Web server 120 is able to determine whether the user entering the search query is a logged-in registered searcher by the presence of the cookie. Where the Web server 120 determines that a search query has been entered by a logged-in registered searcher, the search query and the corresponding searcher's searcher demographic information, as contained in the cookie, are written to a log file and forwarded to the first content filter 730. In alternate embodiments, the searcher computing device 610 or the Web server 120 may be coupled to an account database, which stores information for users that have registered with the service provider. This account database may be accessed by either the searcher computing device 610 or the Web server 120 to retrieve the corresponding user demographic information for the registered user that has entered a search query.

The first content filter 730 is a software object or program, running on the Web server 120. The first content filter 730 receives log files containing search queries and the corresponding user demographic information and IP address from the Web server 120. The first content filter 730 compares the search terms in each search query received from the Web monitoring server 720 with a list of words contained in a “bad words” hash table.

The “bad words” hash table is preferably a file, such as a simple configuration file, stored with or as part of the first content filter 730 or associated memory that contains a list of words, one per line, that are considered to be undesirable to display to the public. The “bad words” hash table may also include words that are likely to display search results that are considered undesirable to display to the public. In addition, each word has a configurable list of suffixes added to cover common pluralizations and inflections. Preferably, an administrator of the system provider is provided access to add, revise, and remove words contained in the “bad words” hash table, without having to make changes to the software object or program code, to allow the system provider to adapt to changes in public culture and advertising strategies. Changes to the “bad words” hash table are generally realized upon server startup, but in alternate embodiments, changes to the “bad words” hash table could be realized immediately upon revisions by the administrator, as a matter of design choice.

The first content filter 730 removes the entire search query if any words contained in the “bad words” hash table are found in the search query. The first content filter 730 splits each remaining search query and the corresponding user demographic information and IP address into component pieces, and forwards these component pieces, such as UDP packets, to the select search server 660.

The select search server 660 is a computing device or processor communicatively coupled to one or more monitoring Web servers 720 by any one of the above-mentioned networks, type of protocols, and the like. The select search server 660 also receives files containing each remaining search query and the corresponding user demographic information and IP address after the filtering process has been completed. The select search server 660 writes each remaining search query to a file, such as an HTML file, that can be accessed by the visual display server 790 to be displayed on the visual display device 795.

The demographic filter 770 is preferably a software object or program running on the select search server 660. The demographic filter 770 reads the remaining search queries stored in memory, along with the searcher demographic information and IP address corresponding to the searcher that entered each search query. The demographic filter 770 compares the corresponding searcher demographic information for the current search query with user information related to a user who will be viewing an advertisement. The demographic filter 770 removes and discards the current search query, unless the corresponding searcher demographic information for the registered searcher is equal to or contained within the range for the field contained in the user information demographics” for the personalized advertisement. The demographic filter 770 stores the remaining search queries and corresponding searcher demographic information and IP address in memory. This process will be described in more detail herein. In certain embodiments, the search queries will be directly written to a file, such as an HTML or XML file, for display in a personalized advertisement, whereby a further process may be used to filter the search queries for display based upon demographics, as described later in this application.

The “desired demographics” used for providing a personalized advertisement wherein search queries are matched with a viewing user may include geographic information (e.g. state, country, or ZIP code), age range, gender, certain Web surfing history and other information that can be collected or identified. The list of fields of “desired demographics” represents the demographics of registered users for which the system provider wishes to display search queries as part of a personalized advertisement.

For example, personalized advertisement content can be provided that displays search queries from persons living in a particular country of a certain age. Therefore, the system would access the “desired demographics” and list the particular country, such as “Japan”, in the demographic field “Country”, and the particular age “35” in the demographic field “Age”. Accordingly, the demographic filter 770 will remove a search query unless the corresponding user demographic information for the registered user who entered that search query has “Japan” listed in the demographic field “Country” and “35” listed in the demographic field “Age”.

Having described exemplary components of the present embodiment, the operation thereof will now be described in greater detail.

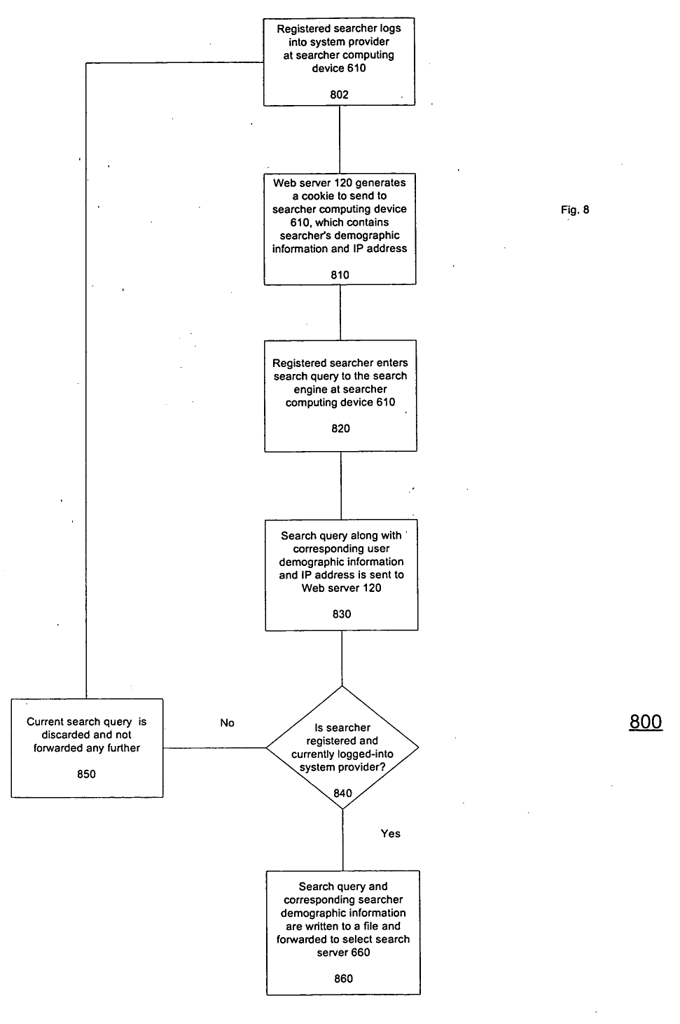

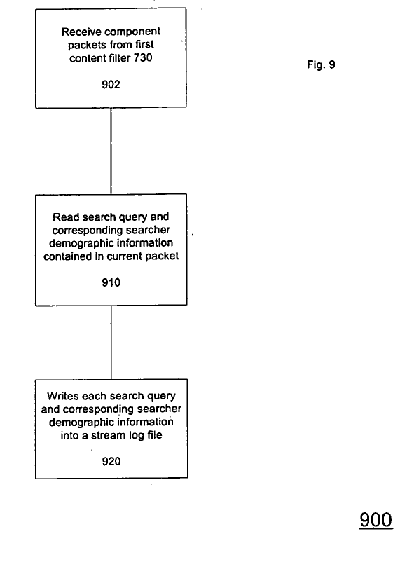

A process 800 for monitoring search queries according to one embodiment of the present invention will now be described with reference to FIG. 8.

In step 802, a registered searcher logs into the system provider at a searcher computing device 610 by entering a previously stored searcher ID and password via a Web page of the system provider at the searcher computing device 610. In step 810, the Web server 120 generates a cookie that is sent to the searcher computing device 610. All subsequent information transmitted from the searcher computing device 610 to the Web server 120 will include this cookie information, which includes the searcher's demographic information (including user's ID) and IP address of the searcher's searcher computing device 610. In step 820, the registered searcher enters a search query to the search engine via a Web page of the system provider at the searcher computing device 610. In step 830, the search query along with the searcher's cookie information is sent to the Web server 120 to allow the Web server 120 to determine whether a registered logged-in searcher has entered the search query. The Web server 120 is able to determine whether the searcher entering the search query is a logged-in registered searcher by the presence of the cookie. If the Web server 120 determines that the searcher entering the search query is not currently registered and logged-into the system provider, in step 840, the search query is disregarded and not forwarded any further, in step 850. The system then proceeds to evaluate another searcher. If the Web server 120 determines that the searcher entering the search query is currently registered and logged-into the system provider, in step 840, the search query and the corresponding searcher's searcher demographic information and IP address are written to a log file and optionally forwarded to filters, in step 860.

A process 900 for reading information from the Web server 120 and writing information to select search server 760 according to one embodiment of the present invention will now be described with reference to FIG. 9.

In step 902, select search server 660 receives the component pieces, namely search query, demographics and IP address, forwarded from the first content filter 730. In step 910, the select search server 660 reads the current search query and the corresponding searcher demographic information and IP address. In step 920, the select search server writes each search query and the corresponding searcher demographic information and IP address into a stream log file. Although a single file or memory location could be used, in the present embodiment, a new stream log file is started after a certain amount of time or after the existing file reaches a certain size, and the previous file is closed and forwarded to the select search server 660. The present embodiment creates a new file every five minutes. This enables the demographic filter 770 to receive search queries in five minute intervals (search query was received within the last 5, 10, 15, 20, etc. minutes). In alternate embodiments, these intervals may be greater than or less than 5 minutes.

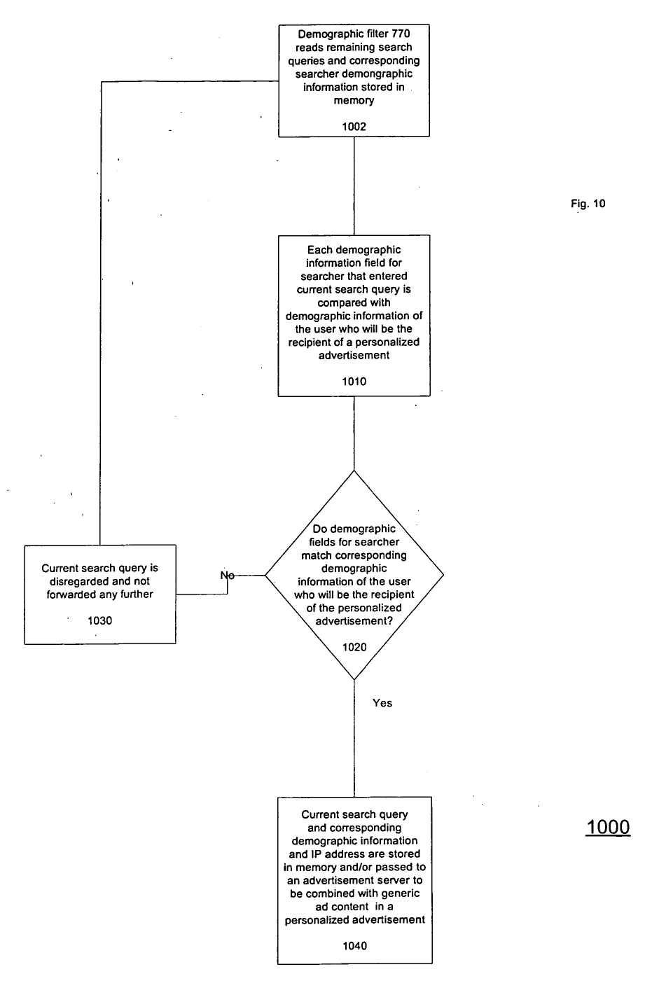

A process 1000 for demographic filtering according to one embodiment of the present invention will now be described with reference to FIG. 10.

In step 1002, the demographic filter 770 reads the search queries and corresponding searcher demographic information and IP address stored in memory. In step 1010, the demographic filter 770 compares each searcher demographic information field for the searcher that entered the current search query with demographic information related to a user who will be the recipient of a personalized advertisement. If the searcher demographic information fields for the searcher submitting the query do not match the corresponding demographic information related to the user who will receive the personalized advertisement, as determined in step 1020, the current search query is disregarded and not forwarded any further, in step 1030. If the searcher demographic information related to a searcher corresponds to demographic information related to a user who will be the recipient of a personalized advertisement in step 1020, the current search query and the corresponding searcher demographic information and IP address are stored in memory, in step 1040.

For example, a searcher enters the search query “britney spears” as described above. This search query passes successfully through both the first content filter 730 and is passed to the demographic filter 770, along with the searcher's corresponding searcher demographic information: (e.g., a female, 22 years old, and from zip code 95060) and IP address of the user's searcher computing device 610. In this illustrative example, the demographic information related to a user who will be the recipient of a personalized advertisement requires: any gender, ages 25-35, and from any location. Since age 22 is not within the desired age range 25-35, the search query “britney spears” would not be forwarded any further in this example.

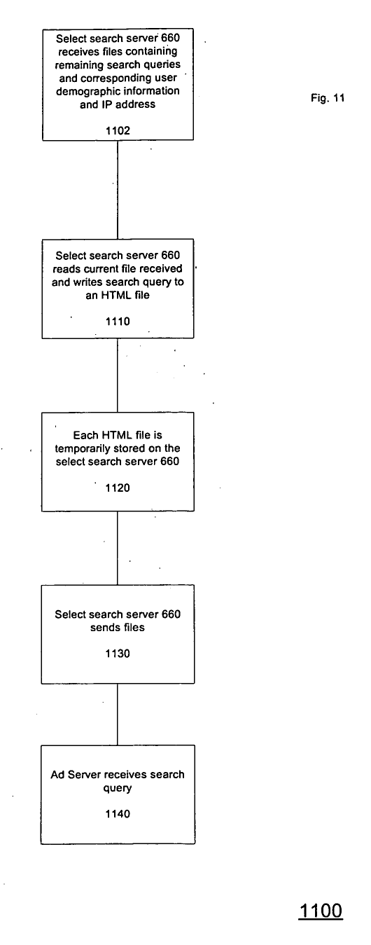

A process 1100 for selecting and sending search queries to the advertising server 130 according to one embodiment of the present invention will now be described with reference to FIG. 11. In step 1102, the select search server 660 receives files, each containing a search query that has passed through the filter and the corresponding searcher demographic information. In step 1110, the select search server 660 reads the current file received and writes the current search query to a file, such as an HTML file. In step 1120, each HTML file is temporarily stored on the select search server 660. In step 1130, the advertisement server 130 signals the select search server 660 to send a certain number of files, for example, 100 HTML files, every minute (to ensure search queries being displayed are in or close to substantially real-time). In alternate embodiments, the number and type of files and amount of time between the sending of files may vary, since it is preferred that search query terms are updated for display often enough to provide a smooth scroll on the displayed “ticker” portion of the perceptible output to show the progress of differing queries over time. The scroll speed may be adjustable to suit the specific medium or environment of presentation. In step 1140, the advertisement server 130 receives and displays the search query contained in the current HTML file so that the search query can be used as personalized advertisement content in combination with generic advertisement content as part of a personalized advertisement.

Persons of skill in the art will recognize that, although the above-referenced system components are discussed and shown as singular units, as a matter of design choice, any number of system components, in varying hardware, software or firmware combinations may be utilized within the scope of the present invention. For example, in alternate embodiments, the system may include multiple monitoring Web servers communicatively coupled to one or more select search servers, which are, in turn, communicatively coupled to one or more visual display servers. Servers may be software or hardware and software or firmware implementation. Additionally, in alternate embodiments, any one or more of the aforementioned filters may be used, in any order, to determine which search queries should be displayed. It is to be understood that any of the aforementioned filters may run, separately or in combination, on any one of the aforementioned servers or any additional components, or may be implemented in fewer or greater number of hardware or software components. Moreover, the specific filtering criteria, demographic criteria, and output format may be flexibly applied as a matter of design choice to provide many different advertisement campaigns, brand affinity campaigns, Web site affinity campaigns, news related informational advertisements, and the like, incorporating search terms or other searcher input obtained in any number of ways, as a matter of design choice.

The system of the present embodiment is also capable of writing or sending different forms of output to be accessed by the display server 790 based on command-line input parameters. Alternately, the search queries may be presented in other perceptible ways, such as audibly, using text to speech conversion, either at the server or at the viewer's output device, or by other known means. Exemplary forms of output are substantially real-time stream and aggregate data. The above-described embodiment is referred to as “aggregate data mode”, because in addition to the first and second content filters, further filters are utilized prior to the select search server 660 writing output to be accessed by the visual display server 790. Such output may take different forms, for example, an XML data feed containing the search queries and/or associated demographic information. In another embodiment, referred to as “substantially real-time stream mode”, the second content filter 760 directly writes resulting lines out to a JavaScript-enabled HTML or XML file, for example, periodically, every 30 seconds. The JavaScript in the file allows a browser to scroll through a list of search queries set by second content filter 760, and to reload the file on a configurable time interval to refresh the displayed scrolling terms. This allows users to see the latest search queries updated and displayed in substantially real-time. For example, search queries and demographic information may be pulled in XML files from the select search server 660 or additional server following the second content filtering to be displayed in an advertisement on a Web page, as described herein in FIGS. 12-17.

In an exemplary embodiment, as shown in FIGS. 12-17, the search queries remaining after some or all of the previously described filtering is shown as used on a Web page, for example, in an advertisement, presented to users via the Internet or other network. FIG. 12a generically illustrates a layout of the exemplary advertisement 1200a of the present embodiment to include a scrolling search query window or “ticker” 1220a having the queries 1210a, (preferably appearing as horizontal scrolling text although the queries may scroll vertically or flash on and off) the advertiser's logo and/or name in another window 1230a and the advertiser's message 1240a. A more specific example of this form of advertisement is illustrated in FIG. 12b, which illustrates the advertiser's, Yahoo!'s logo in one window 1230b, Yahoo!'s advertising message in another window 1240b, and the search queries 1210b scrolling horizontally in the ticker 1220b. Of course the configuration, orientation and visual characteristics of the advertisement or Web page or screen display portion may be flexibly configured any number of ways as a matter of design choice.

In the present embodiment, the advertisement 1200a is a banner advertisement and includes scrolling search queries 1210a that are received and displayed in near real time and that meet certain defined, targeted demographics, although non-real time and generic, non-targeted search queries may be used in alternate embodiments. In the present embodiment, advertisement 1200a is served on a Web site to viewers that typically meet certain demographics and includes filtered search queries 1210a that have been entered by users having the same demographics, thereby providing viewers of the advertisement 1200a with search queries 1210a potentially most relevant to the viewers. In other embodiments, demographics associated with the filtered search queries 1210a are determined, in real-time, for example, to match those of the particular viewer of the advertisement 1200a, for example, as identified by a cookie on the viewer's computer.

It is to be understood that the advertisement 1200a may take any form, such as a banner advertisement, skyscraper advertisement, pop-up advertisement, pop-under advertisement, and the like, with any number and form of visual and other elements. Thus for example a visual display may be offered to searcher in such a manner as to provide a stimulating and highly relevant user experience. The systems and methods herein described may be used to advantage by internet content providers to induce advertisers to serve advertisements on the provider's site, by advertisement agencies seeking to present highly relevant and entertaining advertisements with high user retention potential, by search engines seeking to highlight their services, or by companies offering products and/or services personalized to particular user populations or demographics. For example, a search engine provider could offer the inventions herein described to an advertisement agency that in turn would offer to design an advertisement campaign for a company selling a product. If the product was a basketball sneaker, for example, the advertisement or Web page or visual display could contain information related to the sneaker while also displaying scrolling search terms entered by young males, aged 16-20, from five selected cites. As another example, the inventions herein could be applied to any searches, for example, searches for TV programming, and displayed as part of our on-screen program guide. Thus, a TV network or cable or satellite provider or television guide channel could enable a TV watcher to see what other TV watchers were searching for in a program guide. Other users and applications will be apparent from the teachings herein.

Another exemplary embodiment includes using the advertisement to display search queries entered on a particular partner Web site advertisement that display that partner's logo and advertising message. For example, ABC Company may include a Yahoo! Search query tool bar on its Web site. Visitors to the ABC Web site may thus enter search queries on the Web site. These same queries may be used, either directly or after being filtered by any one or more of the filters described herein, in an advertisement displaying the ABC Company logo, advertising message and/or any other material. Thus, for example, the partner could display a message “Look what others are searching for at ABC Web site,” and actually display such search queries.

In another embodiment, the advertiser specifies filtering criteria that are associated with the product (i.e., good or service) being advertised. Such association may take on any degree of relevance between the filtered search queries and product. For example, such association includes that of genus and species, (e.g., a query of “appliances” and a product being a specific brand and type, such as dishwasher), species and species (e.g., a query for a certain appliance, such as stoves, and a product being another appliance, such as dishwashers) or simply where the product is a possible search result to the query.

Such a personalized advertisement 1200a may be implemented, for example, with the system of FIG. 7, an advertising server (which may be an existing server or a separate server or other computing device or software) for serving the advertisements, and additional advertisement functionality coded in Macromedia FLASH using files with a “.swf” extension (referred to herein as “SWF” files) and a movie clip, although no specific multi-media, graphical or audio/visual is required, but instead may be varied to use various presentation techniques now known or later to become known. An exemplary FLASH-based implementation uses three SWF files—a Shim SWF, a Scroll SWF, and an advertisement SWF. The present exemplary embodiment uses these files to extract the search queries 1210a and demographic information associated with such queries 1210a from an XML document provided by the select search server of FIG. 7. Such XML document is referred to as a feed.

The first SWF file is a Shim SWF. Due to the security model for Flash, version 6, text data cannot be loaded past a subdomain. By way of example, this means that a file on www.yahoo.com would be able to load a file on search.yahoo.com, but would not be able to load a file from the domain other.search.yahoo.com or www.hotjobs.com. An exception to this model is that SWF files can be loaded from any domain. Thus, because the present embodiment includes the text to be loaded, namely the search queries (from the XML feed) and the relevant URLs (e.g., URLs pointing to one or more searchURLs), the Shim SWF is used. More specifically, the Shim SWF is a SWF file that sits on the same server as the text file to be loaded, in the present embodiment, the select search server 660. The Shim SWF has no visual elements. It is one blank keyframe with the exemplary code of FIG. 13 in it. For ease of discussion, the code has been illustrated as segmented into logical units referred to as blocks). Notably, where such a security model is not present (e.g., if Flash, version 7, or some other programming language issued), the Shim SWF is not necessary.

According to the code in Block 1, the Scroll SWF may be loaded with various parameters, which the Scroll SWF uses to set parameters on the Shim SWF, such as any one or more desired demographic criteria and any other parameters defining the advertisement 1200a (in the present embodiment, the number of search queries 1210a (nq), zip-code (zip), age range (age), gender (gen) and radius around the location of the zip code (rad)), to specify what search queries 1210a are to be retrieved. The search queries retrieved from the select search server 660 are personalized to the viewing user, thus personalizing the advertisement. The parameters passed to the select search server 660 are retrieved in any number of ways, including passing them in the form of a cookie, retrieving them from a user database (e.g., based on a user ID in a cookie), and those processes described in connection with FIGS. 5a, 5b and 6. Also, where the parameters are empty or undefined, the server specified in the URL simply ignores those parameters. Certain variables, for example, the variable specifying the number of search queries 1210a, can be set to default values, for example, twenty, in the case of the number of queries 1210a, if no value is set. Where the URL is to be personalized to a certain audience (namely, where the pulled search queries are to meet certain parameters (i.e., criteria), such parameters can be passed to the advertisement SWF file from the html code on which the advertisement 1200a is displayed in any number of ways, including, for example, by appending the parameter names and values in a URL encoded format at the end of the advertisement SWF filename, by using flashbars in conjunction with embed and object tags, javascript code, and the like.

According to the code in Block 2, the basic feed URL is defined, specifying the number of search queries 1210a to return and the requested XML format of the feed. The variable extraParams contains any values defining extra parameters, such as gender, age range, zip code, radius around zip code location and the like, that are used to specify the queries to be retrieved. Adding “&rnd=+Math.random( )” appends an variable and a random number value to the feed URL, which is ignored by the receiving server and makes it more likely that each call for the feed will come from the search server 740 and not from the user's cache, so that reloading the page will repopulate the Scroll SWF with new data.

According to the code in Block 3, an XML object is initialized, specifying what function “parseResults( )”, (defined later in the code) to use on the data it acquires from the feed, and then defining which URL to load the data from (in this embodiment baseURL, which is defined earlier in the code).

According to the code in Block 4, an indicator variable, called “dataState,” is set to the value “loading” so that the Scroll SWF can check on the progress of the feed. This is accomplished by the advertisement SWF checking the value of the indicator variable in a penultimate frame, using a logical check to decide whether to proceed to the final frame or to loop back to an earlier frame and perform a logical check again. When feed data is acquired, dataState will be changed to one of two values depending on the feed's success or failure: “available” or “unavailable”, respectively.

According to the code in Block 5, the function parseResults( ) is called when the XML data object determines that it has loaded the data or it cannot load the data. If the parameter result has usable data, a data object called “items” is created and the XML data is parsed and assembled into the items object. The items object is now available to the Scroll SWF loading the Shim SWF, so the variable dataState is set to “available” and this SWF Scroll ends. If the XML object determines no data can be retrieved, it sets the variable dataState to “unavailable” from which the Scroll SWF determines it will not be given live data from the feed. The Scroll SWF passes this information to the advertisement SWF via its own variable, scrollStatus (see below), while the Shim SWF ends.

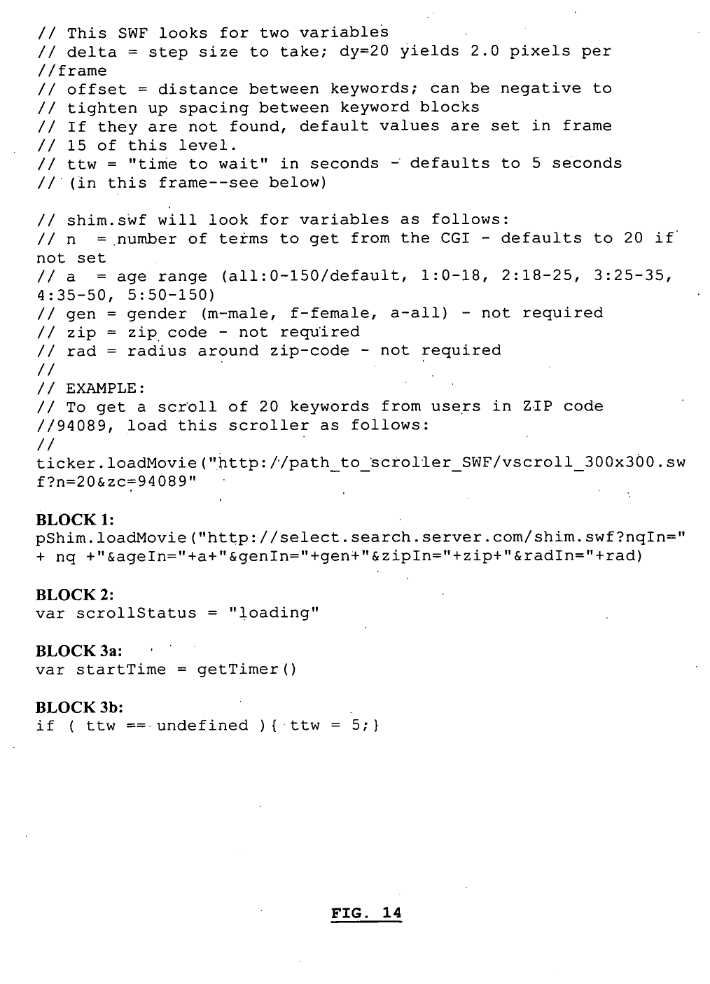

The second SWF file is a Scroll SWF. The Scroll SWF resides on the advertisement server. As described in greater detail below in connection with exemplary Scroll SWF code of FIG. 14, the Scroll SWF calls the Shim SWF to load text and contains code for creating the search query ticker 1220a (scrolling list of the search queries 1210a), including code that pulls search queries 1210a remaining after the filtering process to populate the search ticker 1220a. The Scroll SWF contains a timeline of blank keyframes with code attached to each, which will be described in greater detail below with reference to FIGS. 14-17. The Scroll SWF also contains a template defining what the text field for the search query 1210a should look like and code defining what should happen when the user rolls over the search query 1210a with the mouse or clicks on the search query 1210a. For example, the code in the Scroll SWF may change a search query 1210a from blue to red when the user passes over that search query 1210a with the mouse, along with temporarily halting the scrolling of all of the search queries 1210a in the search ticker 1220a, while the mouse remains on any particular search query 1210a. Additionally, the code in the Scroll SWF may determine whether the search queries 1210a are displayed as scrolling horizontally or vertically. Each block of code begins with an indicator as to where the code is placed.

The Scroll SWF also includes the Scroll Movie Clip, which is implemented as a FLASH movie. The Scroll Movie Clip is a template movie clip in the Scroll SWF that receives the search queries 1210a from the Scroll SWF and defines each pulled search query 1210a as a separate data object, referred to as a search query data object. Each search query data object also may have certain properties associated therewith, as specified in the Scroll Movie Clip.

The Scroll Movie Clip is loaded into a third SWF file, referred to as an advertisement SWF, which is implemented as a FLASH movie. The advertisement SWF resides on the advertisement server and is displayed within a Web page. The advertisement SWF passes to the other movies the variables or parameters necessary to retrieve the correct information for the search ticker 1220a and to have the search ticker 1220a formatted properly. While the advertisement SWF receives the parameters from the html code in the present embodiment, such parameters are hard coded in the advertisement SWF in alternate embodiments. For example, the advertisement SWF may determine which search queries 1210a from the select search server 40 meet the described demographics and should be displayed in the search ticker 1220a. Additionally, the advertisement SWF may cause a banner, title or other advertisement content, such as “Here's what people are searching for:” to be written in the text window 940a and have the scrolling search queries 1210a defined in the Scroll Movie Clip described below, as in FIG. 12a. The advertisement SWF may also define a search tool bar for allowing a user to enter new search queries 1210a.

When a user selects, or clicks on a search query 1210a as it scrolls across the advertisement 1200a, JavaScript written to the advertisement SWF appends the selected search query 1210a to a search URL defined in the javascript and issues a search request to the search server specified in the URL to perform a search on the search query 1210a. In an alternate embodiment, Action script, rather than javascript, is used. More specifically, the Action script makes a “geturl” command, which causes the user's browser to go to the search URL.

As noted above, in the present embodiment, the Scroll Movie Clip additionally filters the remaining search queries 1210a retrieved from the select search server 660 to determine which search queries 1210a should be received by the Scroll Movie Clip and displayed via the advertisement SWF. Such additional filtering may be accomplished in any number of ways, including the advertisement comprising the demographics in the feed for each query 1210a to the parameters of the advertisement or by passing the parameters to the demographic filter described above. It is also to be understood that the search queries retrieved from the select search server may be unfiltered or may be filtered by any one or more of aforementioned filters. In certain alternate embodiments, the Scroll SWF may pull a group (e.g., ten) of remaining search queries 1210a and those search queries 1210a will be included in the Scroll Movie Clip to be repeatedly displayed for a period of time (e.g., five minutes), and then a new group of ten remaining search queries 1210a will be pulled by the Scroll SWF. It should understood by those skilled in the art that the number of search queries 1210a pulled in each group may be greater than or less than ten and the period of time for display of such search queries 1210a may be greater than or less than five minutes. In alternate embodiments, the Scroll SWF will pull remaining search queries 1210a, one at a time, and the current search query 1210a will be displayed in the form of a search query data object immediately following the preceding search query data object within the Scroll Movie Clip.

Exemplary code of the Scroll SWF now will be described in connection with FIGS. 14-17. Although the code is described as associated with particular frames, such frames are exemplary and the code may be implemented in fewer, greater and/or different frames.

In FIG. 14, the code for frame 1 of the root timeline is described. According to the code in Block 1, the Scroll SWF attempts to load the Shim SWF from the select search server 660. The Scroll SWF will, upon loading the Shim SWF, attempt to load the queries 1210a from the feed into a data object available to the Scroll SWF. Parameters to modify the feed, such as, the spacing between search queries and demographic criteria identifying which search queries to receive, can be passed during this step. By changing the parameters passed into the Scroll SWF, search queries 910a meeting such charged parameters can be displayed.

According to the code in Block 2, an indicator variable is set so that the advertisement SWF loading the Scroll SWF can check the status of its progress.

According to the code in Block 3a, the variable “startTime” is set, which stores the time the movie has existed. As such, the variable provides the baseline by which the passage of time is measured.

According to the code in Block 3b, variable “ttw” (time to wait) is set, which indicates to the Scroll SWF how many seconds to wait before giving up on obtaining the feed. In the present embodiment, the default time to wait is set at 5 seconds, if no time to wait value is specified.

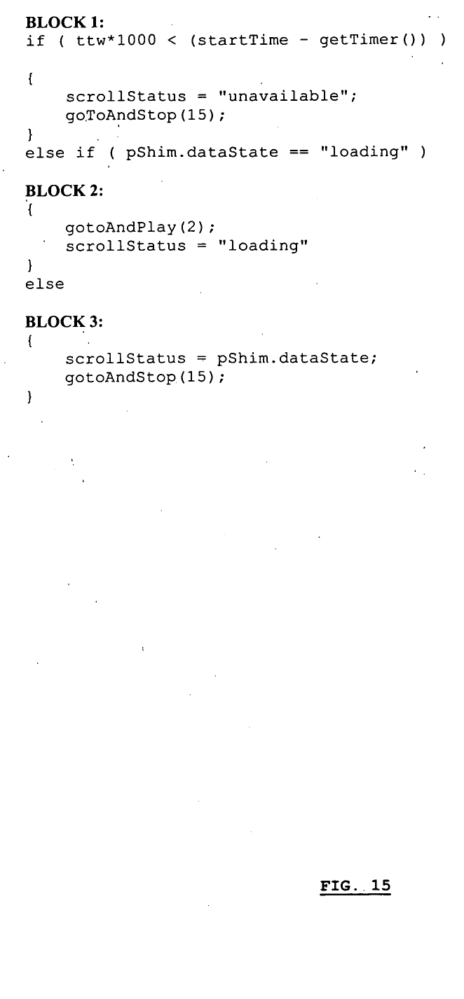

The code for frame 14 of the Scroll SWF will now be described with reference to FIG. 15. During the loading of the data feed, the Scroll SWF code checks the Shim SWF's progress in downloading the feed data, namely, the search queries and associated meta data identifying the query (e.g., demographics).

According to the code in Block 1, if the Scroll SWF has been trying to load the data from the Shim SWF for longer than the time to wait that has been set, the indicator variable “scrollStatus” will be set to “unavailable”, and the Scroll SWF will stop trying to load the data from the Shim SWF and goes to frame 15. The advertisement SWF loading the Scroll SWF will then know data is not forthcoming, and can then take alternate action, such as displaying static data, displaying a more generic advertisement, and the like.

According to the code in Block 2, if the Scroll SWF is still loading the data from the Shim SWF; as indicated by the Shim SWF's variable dataState, the scrollStatus is explicitly set to “loading” (though this should not be a change from the assignment in Frame 1, above), and then return to frame 2.

According to the code in Block 3, if dataState does not equal “loading” (and therefore, will have one of two values, “available” or “unavailable”), the value of dataState should be assigned to scrollStatus and then go to the next frame.

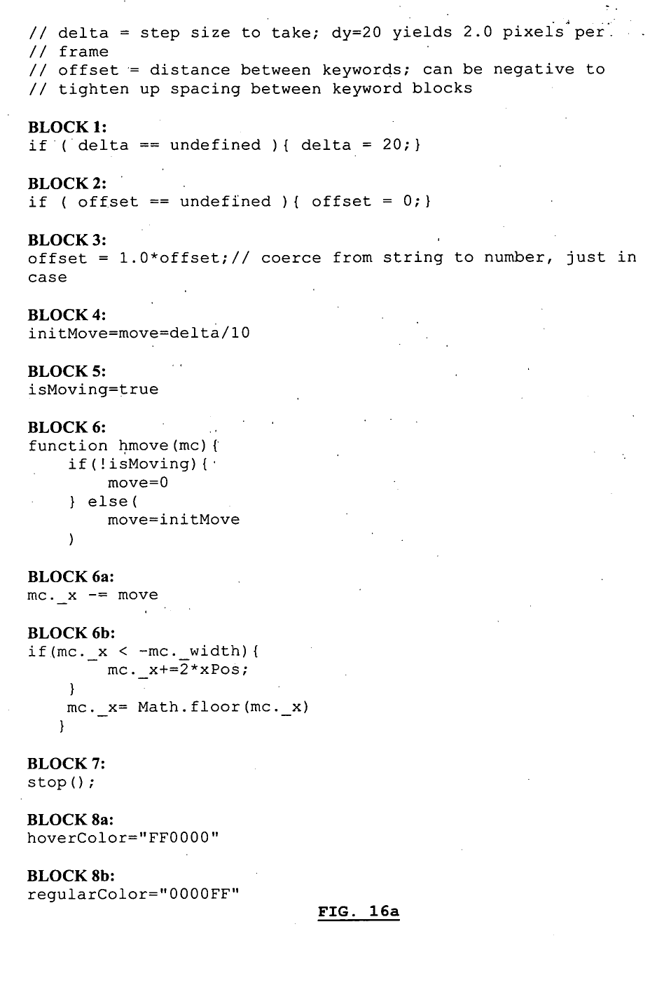

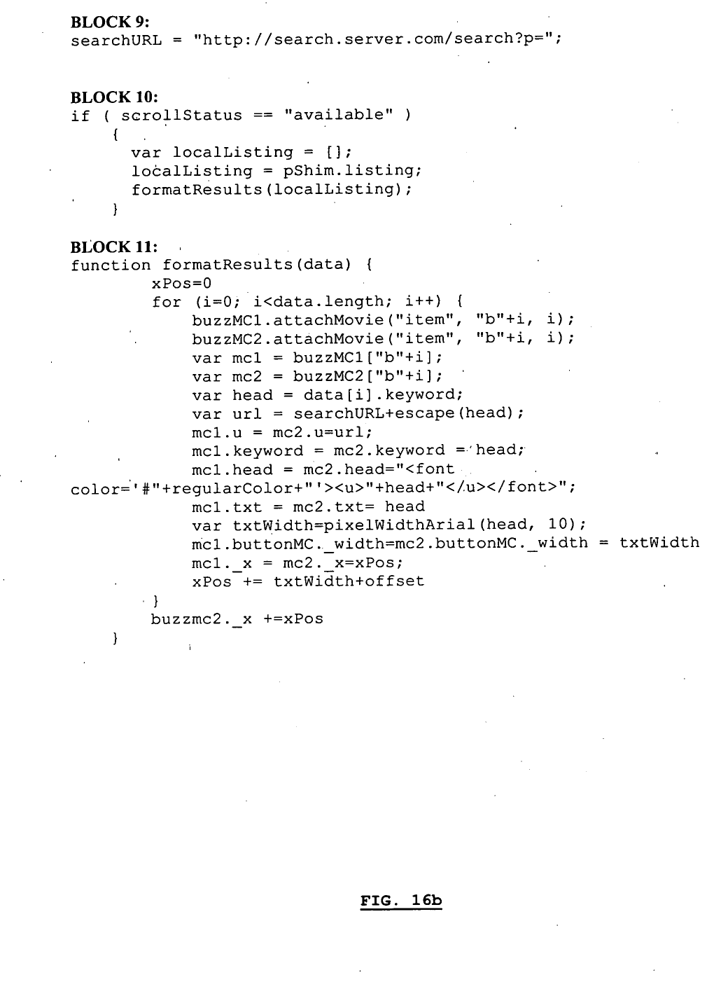

The code for frame 15 of the Scroll SWF will now be described in connection with FIGS. 16a and 16b.

According to the code in Block 1, the variable “delta” defines the amount in pixels to move the Scroll Movie Clip each frame. If no delta value was passed from the URL that loads the Scroll SWF into the advertisement SWF, delta is set to a default value of twenty, which translates to two pixels per frame, although other defaults are possible.

According to the code in Block 2, the variable “offset” defines the distance between consecutive search queries 1210a in the Scroll SWF. If no offset value was passed from the URL that loads this Scroll SWF into an advertisement SWF, the code sets a default value of zero pixels although other defaults are possible. (The value of zero puts consecutive search queries 1210a right next to each other).

According to the code in Block 3, the variable offset is a string by default when passed from the Scroll SWF's URL, so offset must be set to a numerical value. Its intended value remains the same.

According to the code in Block 4, the variables “initmove” and “move” are set to the value of delta divided by ten (delta/10). The value of initMove will not change as the Scroll SWF runs, but the value of move will alternate between 0 and initNove's value, depending on whether the Scroll SWF should move or not (i.e., the Scroll SWF stops when the user mouses over a search query 1210a in the Scroll SWF). By scaling delta by a factor of ten, the string value of delta can be set to a numerical value where delta is passed from the Scroll SWF's URL.

According to the code in Block 5, the variable “is Moving” is a flag for allowing the Scroll SWF to advance by zero pixels, or by the amount defined by delta and initMove. Each search query 1210a in the Scroll SWF can switch this from true to false if it detects a mouse over itself.

According to the code in Block 6, this function block is called by each search query 1310a in the Scroll SWF every time the Scroll SWF is animated. If the Scroll SWF should not be moving, the variable move is set to zero. If the Scroll SWF should be moving, the variable move is set to the default value received from delta.

According to the code in Block 6a, each object in the Scroll SWF moves to the left by the amount in variable move (i.e., either zero or the amount received from delta).

According to the code in Block 6b, the ticker 1220a is presented to appear as a closed loop of search queries 1210a. In the present embodiment, the code creates two copies of the received search queries, presenting them one after another. If the Scroll Movie Clip has gone so far to the left that its second copy is now visible, the first copy is moved to a point beyond the end of the second copy (i.e., so the first copy follows the second copy, thereby maintaining the illusion of an unbroken loop.

According to the code in Block 7, calling the function “stopo” causes the Scroll SWF to stop animating, although the search queries 1210a within the Scroll SWF will continue to move. The Scroll SWF will not loop back to frame 1 and attempt to reload the Shim SWF. According to the code in Blocks 8a and 8b, the color values, “hoverColor” and “regularColor”, for the scrolling search queries 1210a are set to red for when the scroll is not moving due to a mouse-over and blue for when the scroll is moving, respectively.

According to the code in Block 9, the URL builds links to the search site and performs a search on demand for the user. Opening a link to “searchURL” plus a keyword will point to a search results page in the browser for the search query 1210a corresponding to the keyword. In alternate embodiments, the Shim SWF loads a separate search URL for each received search query, where each such URL includes the associated search query 1210a already appended thereto.

According to the code in Block 10, if there is data to be loaded from the Shim SWF, an empty array is created, the array's value is set to the data object listing in the Shim SWF, and the function “formatResults( )” is called to build the Scroll SWF. If there is no feed data to be loaded, the advertisement SWF provides an alternative display, such as static content, an alternate advertisement, a default (static) group of search queries and the like, and not the scrolling ticker 1220a. Such alternate display can be provided in any number of ways, including, for example, running a block of code that, upon determining the data feed to be “unavailable”, specifies that the code use specified data, runs a specified movie, jumps to a certain “default” frame in the movie, and the like. Alternatively, the code could define “buzz” (referenced in the Shim SWF) as being the default display, such as the default queries, and then have the function parseResults( ) call buzz.

According to the code in Block 11, the code builds a separate Scroll Movie Clip for each object in the array passed as data from the Shim SWF to the Scroll SWF. Two copies are made for each object in the array, defined as “mc1” and “mc2” (Scroll Movie Clips 1 and 2). They are for the first and second copy of the Scroll Movie Clips (buzzMC1 and buzzMC2, respectively). The Scroll Movie Clips' properties are set in parallel, as they are essentially, including identical to their relative position within their respective buzzMC1 or buzzMC2. The search queries 1210a in the Scroll Movie Clips have parameters txt, keyword, head, and URL (although the URL is not actually used in the present embodiment). The parameter “keyword” is the actual text of a search query 1210a, as received from the feed and is interchangeable with the property txt. The parameter “head” is the text as displayed by each object in the Scroll SWF, with color and style as defined by HTML tags.

In alternate embodiments, the URL parameter of the Scroll Movie Clip can be used in replace of the function call that causes the URL, including keyword, to be built and passed to the search URL. More specifically, in such alternate embodiments, the user clicks on the (query) link and the code opens the stated URL, such as that of a search page.

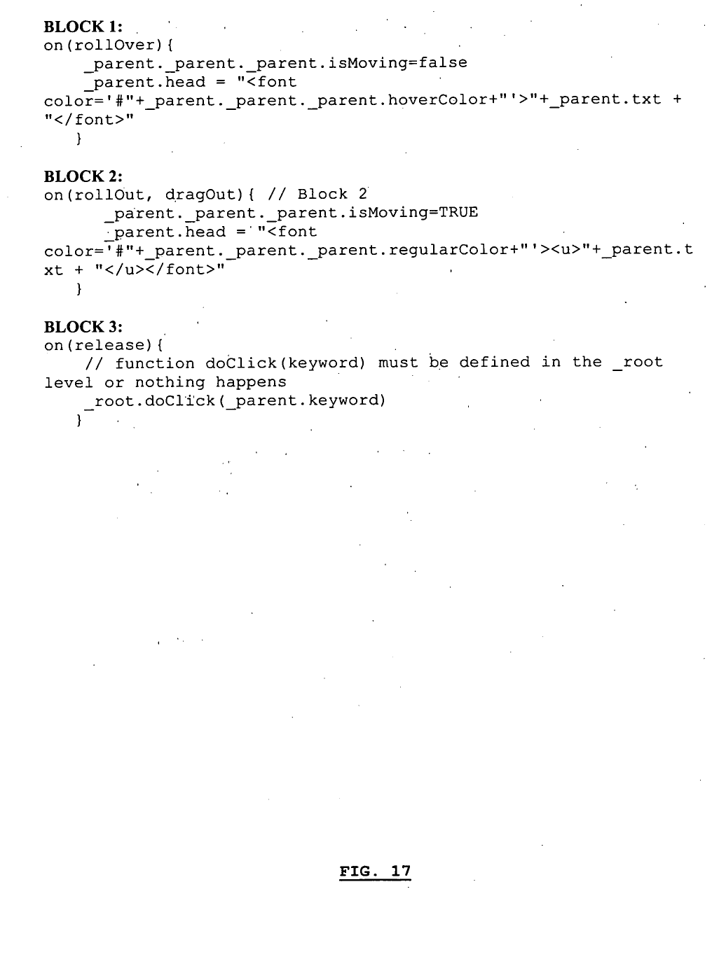

The code for the button inside the search query template will now be described with reference to FIG. 17, which shows the code that each search query 1210a in the Scroll Movie Clip uses to control display and movement of the search ticker 1220a.

According to the code in Block 1, when a search query 1210a detects a mouseover (when the user moves their mouse over the search query 1210a), it stops the search ticker 1320a (setting the Scroll SWF's variable is Moving to false) and changes the search query's color from blue to red.

According to the code in Block 2, when the mouse is no longer over the search query 1310a, the search query 1210a signals the search ticker 1220a to resume, and reverts the search query's appearance to the default state, namely, blue and underlined text.

According to the code in Block 3, if a user clicks a particular search query 1210a, it calls a function “doClick( )”, which is implemented by the advertisement SWF which loads the Scroll SWF into the advertisement 1200a. The function causes the search query 1210a to be passed to the advertisement SWF, which can do whatever it wants with the data, including passing it to a search URL, via the FSCommand/JavaScript approach described earlier. A search is performed and the results are displayed in a new browser window, although in alternate embodiments the results are displayed in the same window. In still other embodiments, rather than performing the search, stored results corresponding to a previously performed search for the selected query 1210a can be retrieved. In other alternate embodiments, the Scroll SWF is loaded along with the page, instead of within the advertisement. In other embodiments, activating the link causes the search to be performed and the results to be displayed in the advertisement 1200a, itself, or on the same page on which the advertisement 1200a is displayed.

As noted above, the filtered search queries may be displayed by any number of display devices. These may be physically or electronically segmented portions of single display, or three separate displays, or combinations thereof, in any size, from a cell phone or PDA display to an outside billboard on a building.

Further, it should be understood by those skilled in the art that the present invention is not limited to the monitoring, filtering, and display of only search queries. In alternate embodiments of the present invention, the input data entered by the user at the user station 10 other than search engine queries can be monitored, filtered, and displayed to one or more persons directly or after additional processing, by any of the aforementioned systems and methods. For example, information entered to an auction Web site, a department store Web site, a video game Web site, and the like, could be used to promote specific products and services to one or more members of the public.

Furthermore, it should be understood that the present invention may be implemented on a network other than the Internet or World Wide Web, such as a corporate intranet, or other communication network now known or hereafter to become known. For example, a corporate information services department may filter users' queries into an on-line “help” application, thereby tracking users' queries, and display answers or tips in response to the most frequently asked queries.

Those skilled in the art will recognize that the method and system of the present invention has many applications, may be implemented in many manners and, as such, is not to be limited by the foregoing exemplary embodiments and examples. Additionally, the functionality of the components of the foregoing embodiments may be implemented in different manners. Further, it is to be understood that the steps in the foregoing embodiments may be performed in any suitable order, combined into fewer steps or divided into more steps. Thus, the scope of the present invention covers conventionally known and future developed variations and modifications to the system components described herein, as would be understood by those skilled in the art.

Thus, while there have been shown and described and pointed out novel features of the present invention as applied to preferred embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto.

It is also to be understood that the following claims are intended to cover all of the generic and specific features of the invention herein described and all statements of the scope of the invention which, as a matter of language, might be the to fall therebetween.

1. A method for providing a personalized advertisement to a user at a computing device, the method comprising:
reading user information related to the user, the user information being electronically stored;
identifying generic advertisement content to be provided to the user;
identifying additional personalized advertisement content personalized to the user based on the user information; and
combining the personalized advertisement content with the generic advertisement content to create the personalized advertisement.

2. The method of claim 1, wherein the generic advertisement content is an advertisement file, and the personalized advertisement is created by inserting the personalized advertisement content into the advertisement file.

3. The method of claim 2, further comprising:
selecting the advertisement file from multiple advertisement files based on user information; then
selecting personalized advertisement content based on user information; and
inserting the personalized advertisement content into the advertisement file.

4. The method of claim 1, further comprising:
causing the personalized advertisement to be provided to the computing device.

5. The method of claim 4, wherein the computing device comprises one or more of a computer, a cell phone, a PDA, and a Web tablet.

6. The method of claim 1, wherein the user information is electronically stored in memory at the computing device.

7. The method of claim 1, wherein the user information is electronically stored in a database remote from the computing device.

8. The method of claim 7, wherein data stored at the computing device identifies the user information in the database.

9. The method of claim 1, wherein user information comprises demographic information.

10. The method of claim 9, wherein demographic information comprises information related to one or more of age, gender, residence address, educational background, religion, nationality and ethnicity.

11. The method of claim 1, wherein user information comprises the user's Web surfing history.

12. The method of claim 1, wherein user information comprises search queries entered by the user.

13. The method of claim 7, wherein the user information is electronically stored in a user sub-database that comprises a subset of information related to the user.

14. The method of claim 8, wherein the data is stored in the form of a cookie.

15. The method of claim 1, further comprising:
receiving a request for a Web page from the computing device, serving the requested Web page to the computing device, the requested Web page calling the personalized advertisement.

16. The method of claim 1, wherein the user information comprises ZIP Code information.

17. The method of claim 1, wherein the generic advertisement content comprises content related to a movie and the additional personalized advertisement content comprises times the movie is playing local to the user.

18. The method of claim 1, wherein the additional personalized advertisement content comprises local movie times.

19. The method of claim 1, wherein the generic advertisement content comprises information related to a product and the additional personalized advertisement content comprises information related to vendors selling the product local to the user.

20. The method of claim 1, wherein the additional personalized advertisement content comprises local movie theater names.

21. The method of claim 1, wherein the additional personalized advertisement content comprises local automobile dealership names.

22. The method of claim 1, wherein the generic advertisement content comprises information related to a product and the additional personalized advertisement content comprises links to Web sites of vendors selling the product local to the user.

23. The method of claim 1, wherein the additional personalized advertisement content comprises links to additional Web sites.

24. The method of claim 1, further comprising providing a coupon to the computing device, the coupon being based on the user information.

25. The method of claim 1, wherein the user information includes first data, the method further comprising:
identifying second data, wherein the personalized advertisement content is identified based on a difference between the first data and the second data.

26. The method of claim 25, wherein the first data is the current date that the user is using the computing device, and the second data is the date of an upcoming event.

27. The method of claim 26, wherein the upcoming event is the release date of a movie.

28. A method for providing a personalized advertisement to a user at a computing device, the method comprising:
reading user information related to the user, the user information being electronically stored;
identifying generic advertisement content to be provided to the user;
receiving search queries from multiple searchers;
filtering the search queries based on filtering criteria, the filtering criteria comprising user information; and
combining the filtered search queries with the generic advertisement content to create the personalized advertisement.

29. The method of claim 28, wherein the personalized advertisement is on behalf of an advertiser, the method further comprising receiving filtering criteria from the advertiser.

30. The method of claim 28, wherein the personalized advertisement is for a product and the filtering criteria include an association between the product and the search queries.

31. The method of claim 28, wherein the personalized advertisement is for a product, the search queries have associated searcher information related to the searchers from which the search queries are received and the filtering criteria comprises demographic criteria, the demographic criteria describing potential purchasers of the product, wherein filtering the search queries comprises identifying search queries having associated searcher information matching the demographic criteria.

32. The method of claim 28, wherein the personalized advertisement comprises a scrolling list of filtered search queries.

33. The method of claim 32, wherein the personalized advertisement comprises a FLASH movie.

34. The method of claim 28, wherein the personalized advertisement comprises a filtered search query link corresponding to one of the filtered search queries, activation of which initiates display of search results corresponding to the one search query.

35. The method of claim 34, wherein the activation of the link further includes display of additional advertising content.

36. A method of providing a personalized advertisement to a user, the method comprising:
receiving one or more search queries from one or more searchers;
selecting personalized advertisement content based on information related to the user to provide as part of the personalized advertisement, the personalized advertisement content comprising one or more of the search queries; and
providing a personalized advertisement to the user, the personalized advertisement including the personalized advertisement content.

37. The method of claim 36, wherein each search query is associated searcher information related to the searcher providing the search query and wherein the selecting of personalized advertisement content comprises matching searcher information related to a searcher with information related to the user.

38. The method of claim 37, wherein the information related to the searcher is stored at a cookie at a computing device used by the searcher.

39. The method of claim 38, wherein the information related to the user is stored at a cookie at a computing device used by the user.

40. The method of claim 37, wherein the information related to the searcher is stored at a user database, and is referenced by way of a searcher ID.

41. The method of claim 38, wherein the information related to the user is stored at a user database, and is referenced by way of a user ID.

42. The method of claim 40, wherein the searcher ID is stored in a cookie at the computing device used by the searcher.

43. The method of claim 41, wherein the user ID is stored in a cookie at the computing device used by the user.

44. The method of claim 36, the display of one or more of the search queries including a scrolling display of the search queries.

45. The method of claim 44, wherein the scrolling display is implemented using a FLASH movie.

46. A system for providing a personalized advertisement to a user at a computing device, the system comprising:
one or more servers configured to:
read user information related to the user, the user information being electronically stored;
identify generic advertisement content to be provided to the user;
identify additional personalized advertisement content personalized to the user based on the user information; and
combine the personalized advertisement content with the generic advertisement content to create the personalized advertisement.

47. The system of claim 46, wherein the generic advertisement content is an advertisement file, and the personalized advertisement is created by inserting the personalized advertisement content into the advertisement file.

48. The system of claim 47, the servers being further configured to:
select the advertisement file from multiple advertisement files based on user information; then
select personalized advertisement content based on user information; and
insert the personalized advertisement content into the advertisement file.

49. The system of claim 46, the servers being further configured to:
cause the personalized advertisement to be provided to the computing device.

50. The system of claim 49, wherein the computing device comprises one or more of a computer, a cell phone, a PDA, and a Web tablet.

51. The system of claim 46, wherein the user information is electronically stored in memory at the computing device.

52. The system of claim 46, wherein the user information is electronically stored in a database remote from the computing device.

53. The system of claim 52, wherein data stored at the computing device identifies the user information in the database.

54. The system of claim 46, wherein user information comprises demographic information.

55. The system of claim 54, wherein demographic information comprises information related to one or more of age, gender, residence address, educational background, religion, nationality and ethnicity.

56. The system of claim 46, wherein user information comprises the user's Web surfing history.

57. The system of claim 46, wherein user information comprises search queries entered by the user.

58. The system of claim 52, wherein the servers are further configured such that user information is electronically stored in a user sub-database that comprises a subset of information related to the user.

59. The system of claim 53, wherein the data is stored in the form of a cookie.

60. The system of claim 46, wherein the servers are further configured to:
receive a request for a Web page from the computing device; and
serve the requested Web page to the computing device, the requested Web page calling the personalized advertisement.

61. The system of claim 46, wherein the user information comprises ZIP Code information.

62. The system of claim 46, wherein the generic advertisement content comprises content related to a movie and the additional personalized advertisement content comprises times the movie is playing local to the user.

63. The system of claim 46, wherein the generic advertisement content comprises content related to a movie and the additional personalized advertisement content comprises information related to theaters playing the movie local to the user.

64. The system of claim 46, wherein the generic advertisement content comprises content related to a product and the additional personalized advertisement content comprises information related to vendors selling the product local to the user.

65. The system of claim 46, wherein the generic advertisement content comprises content related to a product and the additional personalized advertisement content comprises links to additional Web sites of vendors selling the product local to the user.

66. The system of claim 46, wherein the servers are further configured to provide a coupon to the computing device, the coupon based on the user information.

67. A method of providing to a user at a computing device a personalized advertisement that is personalized to the user with reference to first data, the method comprising:
identifying second data;
identifying generic advertisement content to be provided to the user; identifying additional personalized advertisement content personalized to
the user based on a difference between the first data and the second data; and combining the personalized advertisement content with the generic
advertisement content to create the personalized advertisement.

68. The method of claim 60, wherein the first data is a date and the second data is a date the user received the personalized advertisement.

69. The method of claim 61, wherein the first date is a future date.

70. The method of claim 61, wherein the first date is a past date.

71. The method of claim 61, wherein the current date is retrieved from the computing device.

72. The method of claim 60, wherein the current date is retrieved from a remote site.

73. The method of claim 60, wherein the first data is stored in a cookie on the computing device.

74. The method of claim 60, wherein the first data is information related to Web sites the user has visited.

75. A method for providing a personalized advertisement to a user at a computing device, the method comprising:
making a first selection, based on user information, of a selected advertisement file from multiple advertisement files;
making a second selection, based on user information, of a selected personalized advertisement content from multiple items of personalized advertisement content, the selected personalized advertisement content being personalized to the user; and
creating the personalized advertisement by combining the selected personalized advertisement content with the advertisement file.

76. The method of claim 75, further comprising reading user information from electronic storage.

77. The method of claim 76, wherein the electronic storage comprises memory on the computing device.

78. The method of claim 76, wherein the electronic storage comprises an electronic database.

79. The method of claim 75, wherein the first selection is based on user information different from user information on which the second selection is based.
